(19) United States
(12) Patent Application Publication
(10) Pub. No.: US 2003/0219615 A1
(43) Pub. Date: Nov. 27, 2003

(54) Packing material for sheet recording materials and package employing same

(75) Inventors: Yasushi Kikuchi, Fujinomiya-shi (JP); Osamu Kitamura, Fujinomiya-shi (JP)

Correspondence Address: SUGHRUE MION, PLLC, 2100 Pennsylvania Avenue, NW, Washington, DC, 20037-3213, US

(73) Assignee: FUJI PHOTO FILM CO., LTD.

(21) Appl. No.: 10/401,684

(22) Filed: Mar. 31, 2003

(30) Foreign Application Priority Data
Mar. 29, 2002 (JP) 095085/2002

(51) Int. Cl. B32B 7/12

(52) U.S. Cl. 428/537.1; 428/355 CP

(57) ABSTRACT

Disclosed is a packing material for a sheet recording material, which contains a paper material comprising an alkyl ketene dimer and cationic starch, the extraction pH of the paper material being within the range of 6.5 to 9.0. The packing material of the present invention suppresses generation of paper dust and prevents occurrence of white spot defect in recorded images on a sheet recording material even when the packing material is not subjected to surface treatment.

### TECHNICAL FIELD

The present invention relates to a packing material for sheet recording materials and a package employing the same. More particularly, the present invention relates to a packing material that can be employed as the protective carrier for X-ray photography sheet recording materials, and a package employing the same.

### RELATED ART

Sheet recording materials are widely employed in a variety of fields as image recording sheets. Normally, sheet recording materials are packed as a stack of a prescribed number of sheets in a protective carrier such as a packing material. For example, one form of sheet recording material, photothermographic materials, are packed in a protective carrier 1 as shown in FIGS. 1 and 2 so that the stack is maintained. The entire packet of photothermographic materials that has thus been packed in a protective carrier is then sealed with a light-blocking moisture-resistant film to obtain a package that is then distributed.

An image-recording device is normally employed to record images on photothermographic materials. In an image-recording device, unexposed photothermographic material is placed in advance in a film tray shielded from light within the image-recording device, and the photothermographic material is conveyed sheet by sheet, exposed, and developed when image recording is required. It is necessary to reliably place a large quantity of unexposed photothermographic material into the film tray. Thus, the photothermographic material is usually loaded into the film tray while still in the light-blocking moisture-resistant film and the light-blocking moisture-resistant film is removed in a state shielded from light when loading the photothermographic material.

Thus, the photothermographic material is loaded into the film tray while still packed in the protective carrier. In this process, the photothermographic material is often packed with the image-recording surface having an emulsion layer facing downward at the bottom of the protective carrier. Thus, the emulsion surface of the photothermographic material packed at the bottommost position is directly in contact with the bottom surface of the packing material. When in such contact, the emulsion surface is directly affected by paper dust generated by the packing material, moisture contained in the packing material, and chemical compounds. For example, the problem of white spot defect of the image occurs due to paper dust from the protective carrier when the photothermographic material is recorded. Further, the problems of change in the moisture level of the emulsion surface formed by aqueous coating and change in the functioning of the emulsion surface due to the level of moisture contained in the protective carrier also occur. Further, chemical substances contained in the protective carrier sometimes affect components of the emulsion surface, negatively affecting photographic properties. Specifically, problems in the form of changes in sensitivity, color tone, and contrast occur.

Such problems are also present in sheet recording materials other than photothermographic materials. For example, the effect of paper dust from the packing material on sheet recording materials is widely known. Accordingly, great care must be exercised to reduce the effects of the formulas of materials comprising packing materials such as protective carriers on sheet recording materials. In particular, since the characteristics of dry-type sheet recording materials that are developed without a developing solution are greatly affected by the packing material, there is a need to provide packing materials that adequately inhibit effects on photographic properties even when a dry-type sheet recording material is employed.

Accordingly, various efforts have been made to date to formulate the materials comprising the packing material.

For example, Japanese Unexamined Patent Publication (KOKAI) Heisei No. 2-52999 (JP-A-2-52999) discloses a packing material comprised of neutral paper that is hot-extracted at pH 5 to 9 employing 10 to 100 percent kraft process unbleached pulp. Further, JP-A-6-43595, Japanese Examined Patent Publication (KOKOKU) Heisei No. 4-13697 (JP-B-4-13697), and JP-A-2000-147715 disclose packing materials that have been surface treated by coating or the like.

Technical developments such as these have permitted a reduction in the effects of the packing material on the photographic properties of the sheet recording material. However, time and effort are required to perform surface treatments such as coating of the materials comprising the packing material, creating a problem by raising the cost of manufacturing packing materials. Accordingly, there is a need to provide a packing material employing a material having good properties even when not surface treated.

Accordingly, one object of the present invention is to provide a packing material generating little paper dust even without surface treatment and tending not to develop white spot defect on the recorded image due to packing of the sheet recording material. A further object of the present invention is to provide a packing material that effectively prevents the deterioration of photographic properties even when applied to dry-type sheet recording materials. A still further object of the present invention is to provide a packing material with improved hinge durability in addition to the above-listed functions.

### SUMMARY OF THE INVENTION

The present inventors conducted extensive research, resulting in the discovery that the use of paperboard satisfying prescribed conditions yielded a packing material achieving the above-stated objects; the present invention was devised on that basis.

That is, the present invention provides a packing material for a sheet recording material characterized by comprising a paper material comprising an alkyl ketene dimer and cationic starch wherein the extraction pH of the paper material is in the rage of 6.5 to 9.0. In the packing material of the present invention, 50 weight percent or more of the starting material for producing the paper material is desirably a needle-leaf-tree bleached kraft pulp (NBKP) that has been bleached by the ECF method. Further, in the packing material of the present invention, the sheet recording material is desirably stored with a portion or all of the material being in direct contact with the packing material.

Further, the present invention provides a package in which an X-ray photographic sheet recording material is packed in the above-described packing material for sheet recording materials. Further, the present invention provides a package in which a photothermographic material or heat-sensitive recording material is packed in the above-described packing material for a sheet recording material.

### BRIEF DESCRIPTION OF THE FIGURES

FIG. 1 is a perspective view of an embodiment of the packing material of the present invention.

FIG. 2 is a perspective view of another embodiment of the packing material of the present invention.

FIG. 3 is a perspective view of the state that a packing material in which sheet recording materials have been packed is contained in a moisture-resistant bag.

FIG. 4 is a perspective view of the state that a label is attached to a moisture-resistant bag containing a packing material in which has been packed a sheet recording material.

FIG. 5 is a schematic drawing showing the state that a packing material containing a sheet recording material is loaded into a cassette for an image recording device while the packing material still remains in a moisture-resistant bag.

### BEST MODE OF IMPLEMENTING THE INVENTION

The packing material for sheet recording materials of the present invention is described in detail below. In the present specification, ranges indicated with “-” mean ranges including the numerical values before and after “-” as the minimum and maximum values.

The packing material for sheet recording materials is characterized by comprising a paper material comprising an alkyl ketene dimer and cationic starch and an extraction pH of the paper material is in the range of 6.5 to 9.0. So long as the paper material employed in the present invention satisfies these conditions, the method of manufacturing and material itself are not specifically limited and conventional methods may be employed.

The paper material employed in the packing material of the present invention is manufactured from pulp. The type of pulp employed in the present invention is not specifically limited, but is usually a natural wood pulp such as a conifer pulp, a broadleaf pulp, or a mixture thereof. In the present invention, conifer pulp is desirably employed and a needle-leaf-tree bleached kraft pulp (NBKP) is more preferably employed. Particularly desirable results are achieved when 100 percent pine pulp is employed. The long fibers contained therein remarkably promote the effects of sizing agents and paper strengthening agents, and prevent generation of paper dust or fluff.

Further, the pulp employed in the present invention may be manufactured by any method. Specifically, mechanical pulp, chemical pulp, and semichemical pulp may be employed. Recycled paper pulp such as cellulose pulp may also be suitably incorporated.

The paper material employed in the present invention may be bleached or unbleached. A bleached paper material is preferred. The ECF method of bleaching is preferably employed. The use of NBKP pulp that has been bleached by the ECF method is particularly preferred in the present invention. In particular, 50 weight percent or more of the paperboard starting material employed in the present invention is desirably NBKP pulp that has been bleached by the ECF method.

The basis weight of the paper material employed in the present invention is desirably from 250 to 400 g/m², preferably from 270 to 350 g/m².

Alkyl ketene dimer is employed as a sizing agent in the present invention. The type of alkyl ketene dimer employed in the present invention is not specifically limited so long as the alkyl ketene dimer has a function of sizing. Typical alkyl ketene dimers have the following structural formula:

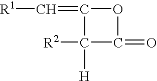

In the formula, R¹ and R2 each independently represents an alkyl group. The number of carbon atoms in the alkyl groups of R¹ and R² is desirably 8 to 30, preferably 10 to 20. Examples of the alkyl groups of R¹ and R² are: n-decyl, n-undecyl, n-dodecyl, n-tridecyl, n-tetradecyl, n-pentadecyl, n-hexanedecyl, n-heptadecyl, and n-octadecyl groups. Alkyl groups R¹ and R2 may be the same or different. The alkyl ketene dimer employed in the present invention may be a mixture of two or more dimers.

The alkyl ketene dimer may be dispersed in water to obtain a sizing agent. In the course of preparing the dispersion, a cationic or nonionic dispersing agent may be suitably employed. Suitable additives may be added to the sizing agent. For example, the additives described in JP-B-63-38478 and JP-B-63-38479 may be suitably employed.

The sizing agent comprising an alkyl ketene dimer is normally employed in an amount of 0.001 to 5 weight percent, preferably 0.01 to 2 weight percent of the pulp fiber based on dry weight. When a sizing agent comprising an alkyl ketene dimer is employed to prepare a paper material and the paper material and the sheet recording material are brought into contact, water transfer between the image recording surfaces (emulsion surfaces) of the sheet recording material and the paper material is effectively prevented.

The extraction pH is made from 6.5 to 9.0 to utilize the sizing effect of the alkyl ketene polymer. Commonly known aluminum sulfate and resin-based sizing agents exhibit sizing effects in the acid range, but alkyl ketene dimers exhibit sizing effects in the alkali range.

Further, cationic starch is employed as a fixing agent in the present invention. In addition to cationic starch, other fixing agents such as synthetic polymers may be suitably combined for use in the present invention. When synthetic polymers are combined for use, active cationic polymers are desirably employed.

The method of making paper is not specifically limited. Conventionally employed paper-making methods may be suitably employed. A cylinder paper machine or a Fourdrinier paper machine may be employed to make paper, but the use of a Fourdrinier paper machine is preferred.

The paper material employed in the present invention may be a commercial product so long as it comprises an alkyl ketene dimer and cationic starch and has an extraction pH of from 6.5 to 9.0. For example, Prime made by Stora Enso that is conventionally used as a raw paper for the paper container may be employed herein.

The paper material employed in the present invention may be employed as a packing material in the form of the raw paper. That is, the effects of the objects of the present invention may be achieved using the paper stock. However, to more fully develop the effects of the present invention, the paper stock is desirably surface treated. Various methods of surface treatment may be employed. Of these, the preferred method is the application of a coating of UV-setting resin. Specifically, the UV-setting resin described in JP-B-4-13697 may be employed. The thickness of the coating layer of UV-setting resin is desirably from 0.05 to 15 micrometers, preferably from 0.1 to 5 micrometers.

The structure of the packing material of the present invention will be described next.

The packing material of the present invention prevents generation of paper dust and fluff. Thus, the packing material of the present invention can be widely employed as a material in the packing of sheet recording materials. For example, it may have a structure in which it comes in direct contact with the sheet recording material; a structure in which there is the possibility of direct contact depending on the sheet recording material; or a structure in which it does not come in contact with the sheet recording material. A structure in which at least a portion of the packing material comes in contact with at least a portion of the sheet packing material is preferred. The packing material of the present invention exerts a smaller effect on the photographic properties of the sheet recording material than conventional packing materials even when stored for extended periods in contact with the recording surface of a dry-type sheet recording material. Specifically, it inhibits changes in the sensitivity of the sheet recording material and reduces the possibility of the occurrence of white spot defect of recorded images. Accordingly, the packing material of the present invention can be effectively employed in a state where the packing is in direct contact with the recording surface of a sheet recording material, particularly a dry-type sheet recording material.

At least a portion of the packing material of the present invention is comprised of a paper material having an extraction pH of from 6.5 to 9.0 and containing an alkyl ketene dimer and cationic starch. For example, such a paper material can be employed as the portion in contact with the sheet recording material, and materials other than the paper material can be employed for other portions. In consideration of the ease of processing and environmental issues when discarding waste, a packing material comprised entirely of the paper material is desirably employed.

The packing material of the present invention is not limited to a structure in which the sheet recording material is completely covered. A case having openings for loading and unloading the protective carrier and a structure contacting a portion of the sheet recording material (for example, a plate shape or L-shape) are possible. A structure facilitating insertion of the exposure device and developing device that does not create passage problems is desirable.

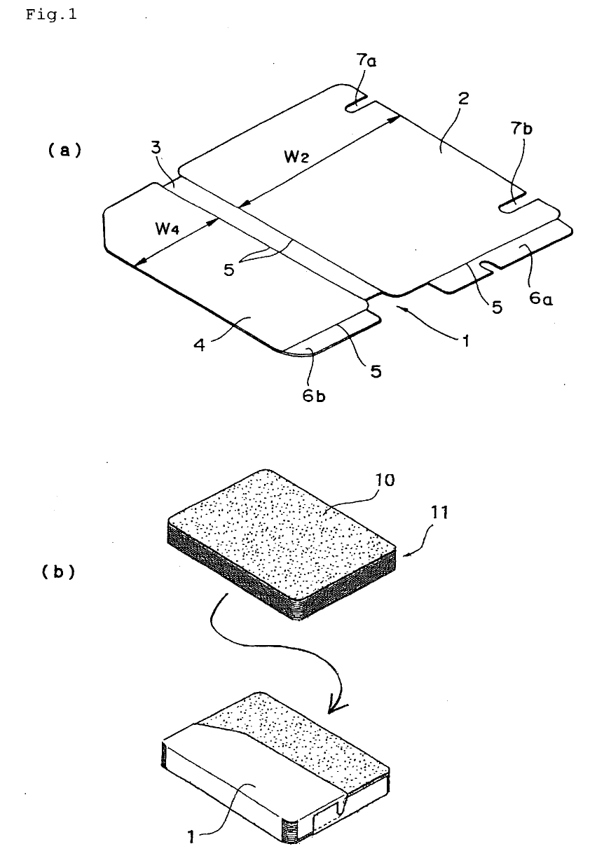

A typical structure (protective carrier) of the packing material of the present invention will be described with FIG. 1.

A paper material having an extraction pH of from 6.5 to 9.0 and comprising an alkyl ketene dimer and cationic starch is first processed by punching or the like into the shape shown in FIG. 1(a). In FIG. 1(a), a bottom (2), connecting member (3), and top (4) are integrated into a single body. Folding to about 90° along rule lines 5 yields a protective carrier (packing material) 1. In the figure, 6a and 6b denote flaps and 7a and 7b denote notches. A stack 11 of sheet recording material 10 of prescribed size is loaded as shown in FIG. 1(b) into protective carrier 1. The bottom surface 2 of protective carrier 1 is of roughly the same size as sheet recording material 10. Notches 7a and 7b formed in bottom surface 2 are completely covered by sheet recording material 10 that is placed on bottom surface 2. Stack 11 of sheet recording material is loaded in such a manner that the bottom surface, two lateral surfaces, and a portion of the top thereof come into contact with protective carrier 1.

The width W₄ of top surface 4 of protective carrier 1 is desirably greater than or equal to 50.5 percent, preferably greater than or equal to 51.5 percent, and more preferably, greater than or equal to 53 percent, of the width W₂ of bottom surface 2. The upper limit is set so that the discharge of sheet recording material 10 is not impaired. For example, in the course of exposing the stacked sheet recording material, when a device is employed in which the sheet recording material is picked up by a sheet recording material suction cup (referred to simply as a “suction cup” hereinafter) and conveyed to an exposure element, the upper surface must have an opening large enough not to impede adhesion by the suction cup. The upper limit of width W₄ of top surface 4 of protective carrier 1 varies with the size of sheet recording material 10, but, for example, is desirably less than or equal to 70 percent, preferably less than or equal to 60 percent, of width W₂ of bottom surface 2.

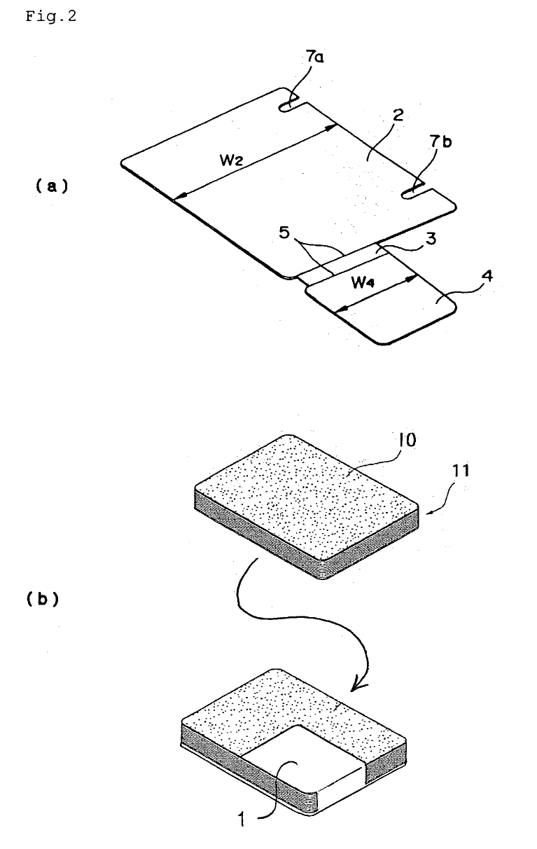

FIG. 2 shows another representative structure of the packing material (protective carrier) of the present invention.

The protective carrier of FIG. 2 differs from the protective carrier of FIG. 1 in that there are no flaps and in that the positional relation of notches 7a and 7b to top 4 differs. Protective carrier (packing material 1) is assembled by folding to the inside along rule lines 5 of FIG. 2(a) by about 90 degrees. FIG. 2(b) is a drawing of how a stack 11 of sheet recording material 10 is packed into protective carrier 1. Stack 11 of sheet recording material is packed so that the bottom surface, one of the lateral sides, and a portion of the top thereof are in contact with protective carrier 1. The relation between the width W₄ of top surface 4 of protective carrier 1 and the width W₂ of bottom surface 2 is identical to that of the packing material of FIG. 1.

In contrast to the packing material of FIG. 1, the packing material of FIG. 2 affords the advantage of not requiring that the flaps be put together during assembly.

The structure of the packing material of the present invention may be suitably modified based on the objective in ways differing from FIGS. 1 and 2.

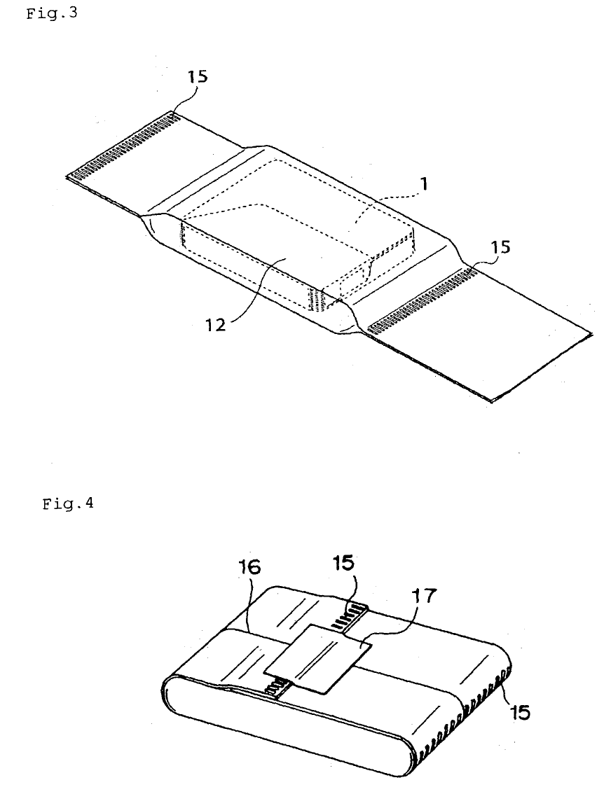

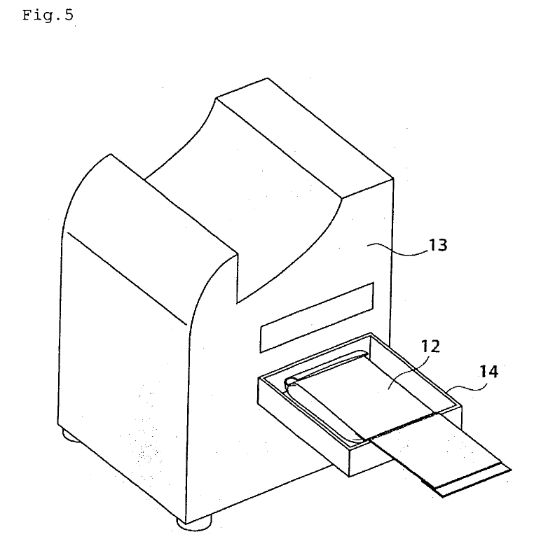

Usually, the entire protective carrier into which the stack of sheet recording material has been packed is inserted into a light-blocking, moisture-resistant bag, preferably a complete light-blocking, moisture-resistant bag, and sealed. The moisture-resistant bag is prepared by continuously bonding with heat seal (center sealing) the two edges of a long roll of moisture-resistant film. A protective carrier packed with a stack of sheet recording material is sealed by inserting it into the tubular moisture-resistant bag, degassing it, and heat sealing it (cross sealed) at positions 15 shown in FIG. 3. Subsequently, as shown in FIG. 4, the two ends are folded over and secured with a label 17. The heat seal (center seal) 16 applied is usually positioned at center top when processing the sheet of moisture-resistant film into a tubular member. The heat seal is thicker than other portions of the moisture-resistant bag, with a load tending to concentrate on the protective carrier due to external pressure. Thus, making the width W₄ of the top surface of the protective carrier greater than or equal to 50.5 percent of the width W₂ of the bottom surface, as set forth above, protects the sheet recording material by dispersing the load exerted through the heat seal portion through the top surface to the sheet recording material.

The protective carrier inserted into a moisture-resistant bag processed as shown in FIG. 4 is then packed, for example, into a zippered decorative box. Five of these boxes are then packed into a cardboard box and sealed for distribution.

When recording an image on the sheet recording material, an image recording device is generally employed. When recording an image with a conventional image recording device, the sheet recording material protected by a protective carrier is loaded into the cassette 14 of an image recording device 13 while still in the light-blocking bag. Next, one end of the light-blocking bag is cut, the cassette is closed as shown in FIG. 5 to block light, and the light-blocking bag is pulled to remove only the light-blocking bag from the cassette.

In this manner, the sheet recording material is pulled with suction cups sheet by sheet from the protective carrier loaded into the cassette of the image recording device, and conveyed to the exposure element. The suction cups are configured to contact the portions corresponding to the notches formed in the protective carrier. When all the unexposed sheets of recording material in the film tray have been conveyed out, air flows into the suction cups through the notches, making it possible to detect that all the sheets of recording material have been used up.

In this manner, the packing material of the present invention must be of suitable strength to maintain its structure in the series of steps of loading the sheet recording material, wrapping in the moisture-resistant bag, conveyance, loading into the image recording device, and suction by the suction cups. The paper material employed in the packing material of the present invention can fully respond to such demands due to high hinge strength.

The packing material of the present invention can be employed to pack the sheet recording material. The sheet recording material that is packed is not specifically limited other than that it be in sheet form and be capable of recording an image by some recording method. Nor is the shape of the sheet specifically limited; it may be square, rectangular, or round, for example. Nor is the thickness of the sheet specifically limited. Examples of conventional sheet recording materials are recording materials of fixed size, such as half-size, B4, large-angle, and sixth-size.

The sheet recording material may be recorded on only one side, or may be recorded on both sides. The sheet recording material that is desirably packed into the packing material of the present invention is sheet recording material employed in X-ray photography. Another type of sheet recording material the packing of which is desirable from another perspective is dry-type sheet recording material that is developed without a developing solution. Examples are photothermographic materials and heat-sensitive recording materials. Dry-type sheet recording materials are characteristically affected to a greater degree by the packing material. However, when packed in the packing material of the present invention, it is possible to adequately inhibit the effects of packing and subsequent conveyance on photographic properties. Specifically, changes in the sensitivity of the sheet recording material are prevented, and the problem of white spot defect of the recorded image is avoided.

Next, photothermographic materials will be described. The phoththermographic materials are conventional sheet recording materials that can be packed in the packing material of the present invention.

The photothermographic materials are configured of a support on one surface of which are provided at least a non-photosensitive organic silver salt, a silver-ion reducing agent, and a binder. The organic silver salt and the binder are contained in an image-forming layer. The image-forming layer desirably further comprises a reducing agent for the silver ions of the organic silver salt. The photothermographic material further desirably comprises a photosensitive layer containing a photosensitive silver halide and a binder. The image-forming layer preferably comprises a photosensitive silver halide and functions as a photosensitive layer. In such a photothermographic material, the image-forming layer, preferably the photosensitive image-forming layer, comprises a primary binder in the form of a polymer that permits aqueous application using a coating liquid the solvent of which comprises 30% by weight of water, which is considered environmentally safe; delivers good photographic performance; and has an equilibrium moisture content of less than or equal to 2% by weight at 25° C. and 60% relative humidity. The description below specifically relates to an example of a photothermographic material comprising a photosensitive silver halide in an image-forming layer. The photothermographic material is desirably a monosheet (permitting the formation of an image on the photothermographic material without the use of another sheet such as an image-receiving material). This is particularly effective in a photothermographic materials designed for exposure to red-to-infrared radiation.

The photothermographic material contains a reducing agent for an organic silver salt. The reducing agent for an organic silver salt need only be a substance (preferably an organic substance) that reduces the metallic silver in silver ions. Such reducing agents are described in paragraph nos. 0043 to 0045 in JP-A-11-65021 and from line 34, page 7, to line 12, page 18, of European Patent Publication No. 0803764. Of these, bisphenol reducing agents (for example, 1,1-bis(2-hydroxy-3,5-dimethylphenyl)-3,5,5-trimethylhexane) are preferred. The quantity of reducing agent added is desirably 0.01 to 5.0 g/m², preferably 0.1 to 3.0 g/m². It is desirable for 5 to 50 molar percent, preferably 10 to 40 molar percent, to be added per mol of silver on the surface where the image-forming layer is present. The reducing agent is desirably incorporated into the image-forming layer.

The reducing agent is incorporated into the coating liquid in the form of a solution, dispersed in an emulsion, as solid microparticles, or the like, and can be incorporated into the photothermographic material. In the example of the well-known emulsion dispersion method, the reducing agent is dissolved in an oil such as dibutyl phthalate, tricresyl phosphate, glyceryl triacetate, or diethyl phthalate using a complementary solvent such as ethyl acetate or cyclohexanone and an emulsion dispersion is prepared mechanically. As an example of a solid microparticle dispersion method, a powder of the reducing agent is dispersed in a suitable solvent, such as water, in a ball mill, colloid mill, vibrating ball mill, sand mill, jet mill, roller mill, or by means of ultrasound, to prepare a solid dispersion. In the process, protective colloids (for example, polyvinyl alcohol) and surfactants (for example, anionic surfactants such as sodium triisopropylnaphthalene sulfonate (a mixture of compounds having different substitution sites for three isopropyl groups)) may be employed. Preservatives (for example, benzisothiazolinone sodium salt) may also be incorporated into aqueous dispersions.

The halogen composition of the photosensitive silver halide employed in the photothermographic material is not specifically limited; silver chloride, silver chlorobromide, silver bromide, silver iodobromide, and silver iodochlorobromide may be employed. The halogen composition may be uniformly distributed, may vary in steps, or may vary continuously within the molecule. Silver halide particles having a core/shell structure are preferably employed. Core/shell particles of double to quintuple structure are desirably employed, with those of double to quadruple structure being preferred. Techniques of locally positioning silver bromide on the surface of silver chloride or silver chlorobromide particles are also desirably employed. Methods of forming photosensitive silver halides are well known in the trade. For example, the methods described in Research Disclosure No. 17029, June, 1978, and U.S. Pat. No. 3,700,458 may be employed. Specifically, a method in which a photosensitive silver halide is prepared by adding a silver-providing compound and halogen-providing compound to a gelatin or other polymer solution, and then admixing an organic silver salt may be employed.

The particle size of the photosensitive silver halide is desirably small to decrease clouding after image formation. Specifically, a particle size of less than or equal to 0.20 micrometer is desirable, with 0.01 to 0.15 micrometer being preferred and 0.02 to 0.12 micrometer being of greater preference. What is meant here by the “particle size” is the diameter of a sphere having a volume equal to the silver halide particle when the silver halide particle is a normal cubic or octahedral crystal, or when it is not a normal crystal, such as when it is a spherical particle, rod-shaped particle, or the like; and is the diameter converted to a circle with an area identical to the projected area of the main surface when the silver halide particle is tabular.

The shape of the silver halide particle may be cubic, octahedral, tabular, spherical, rod-shaped, potato-shaped, or the like, with cubic particles being preferred. Silver halide particles with rounded corners are also desirably employed. The mirror index of the outer surface of the photosensitive silver halide particles is not specifically limited. However, the ratio of {100} faces of high spectral sensitization efficiency when a spectral sensitization dye is adsorbed is desirably high. This ratio is desirably greater than or equal to 50 percent, preferably greater than or equal to 65 percent, and more preferably greater than or equal to 80 percent. The ratio of mirror index {100} faces can be calculated by the method described by T. Tani in J. Imaging Sci., 29, 165 (1985) using the adsorption dependence of the {111} faces and the {100} faces in the adsorption of sensitization dyes.

The photosensitive silver halide particles contain group VIII to X metals, or metal complexes, of the Periodic Table of the Elements (showing groups I through XVIII). The group VIII to X metals of the Periodic Table of the Elements employed, or core metals of metal complexes employed, are desirably rhodium, rhenium, ruthenium, osmium, or iridium. A single metal complex may be employed, or two or more complexes of homogeneous or heterogeneous metals may be employed. The preferred content falls within a range of from 1×10⁻⁹ mol to 1×10⁻³ mol per mol of silver. These metal complexes are described at paragraphs 0018 to 0024 in JP-A-11-65021.

Of these, the incorporation of iridium compounds into the silver halide particles is desirable. Examples of iridium compounds are hexachloroiridium, hexaammineiridium, trioxalatoiridium, hexacyanoiridium, and pentachloronitrosyliridium. These iridium compounds are dissolved in a suitable solvent such as water for use. One of the common methods, such as adding a hydrogen halide aqueous solution (such as hydrochloric acid, bromic acid, or hydrofluoric acid) or an alkali halide (such as KCl, NaCl, KBr, or NaBr) may be employed to stabilize the solution of iridium compound. Instead of employing water-soluble iridium, when preparing a silver halide, some other silver halide particle that has been doped with iridium in advance may be added and dissolved. The quantity of iridium compound added desirably falls within a range of from 1×10⁻⁸ mol to 1×10⁻³ mol, preferably within a range of from 1×10⁻⁷ mol to 5×10⁻⁴ mol, per mol of silver halide.

Metal atoms (for example, [Fe(CN)₆] ⁴⁻) that can be incorporated into the silver halide particles employed in the photothermographic material, desalting methods, and chemical sensitization methods are described at paragraphs 0046 to 0050 in JP-A-11-84574 and at paragraphs 0025-0031 in JP-A-11-65021. Photosensitive silver halide emulsions may be employed singly or in combinations of two or more (for example, emulsions differing in average particle size, halogen composition, crystal habit, or chemical sensitization conditions) in photothermographic materials. The use of multiple types of photosensitive silver halides of differing sensitivity permits the adjustment of gradation. Examples of such techniques are JP-A-57-119341, JP-A-53-106125, JP-A-47-3929, JP-A-48-55730, JP-A-46-5187, JP-A-50-73627, and JP-A-57-150841. A sensitivity difference of greater than or equal to 0.2 logE is desirably imparted by means of the emulsions.

The quantity of photosensitive silver halide added, expressed as the amount of silver coated per m² of photothermographic material, is desirably from 0.03 to 0.6 g/m², preferably from 0.05 to 0.4 g/m², and more preferably from 0.1 to 0.4 g/m². From 0.01 to 0.5 mol, preferably from 0.02 to 0.3 mol, and more preferably from 0.03 to 0.25 mol of photosensitive silver halide is added per mol of organic silver salt. The methods and conditions for mixing separately prepared photosensitive silver halides and organic silver salts are not specifically limited. There are methods of mixing separately prepared silver halide particles and organic salts in high-speed stirrers, ball mills, sand mills, colloidal mills, vibrating mills, and homogenizers. There are also methods of preparing organic silver salts by mixing photosensitive silver halides that have been prepared based on some timing in the preparation of the organic silver salts.

The silver halide is desirably added to the coating liquid of the image-forming layer from 180 min to immediately prior to coating, or from 60 min to 10 sec prior to coating; there is no specific limitation. Specific methods of mixing include the method of mixing in a tank so as to achieve a desired average retention time calculated from the addition flow rate and the amount of liquid fed to the coater, and the method employing a static mixer described in Chapter 8 of “Liquid Mixing Techniques” by N. Harnby, M. F. Edwards, and A. W. Nienow, translated by K. Takahashi (published by Nikkan Kogyo Shinbunsha, 1989).

Since silver halide particles can be spectrally sensitized in a desired wavelength range when sensitizing dyes suited to use in photothermographic materials are adsorbed onto silver halide particles, sensitizing dyes having spectral sensitivity suited to the spectral characteristics of an exposure light source can be advantageously selected. Sensitization dyes and addition methods are described at paragraphs 0103 to 0109 in JP-A-11-65021, the compounds denoted by general formula (II) in JP-A-10-186572, and from line 38, page 19, to line 35, page 20 of European Patent Publication No. 0803764. The sensitizing dyes are desirably added to the silver halide emulsion in the present invention following the desalting step and prior to coating, more preferably following the desalting step and prior to the start of chemical aging.

Examples of antifogging agents, stabilizers, and stabilizer precursors that can be employed in the photothermographic material are those described at paragraph 0070 of JP-A-10-62899, and from line 57, page 20 to line 7, page 21 in European Patent Publication 0803764. Further, the antifogging agents employed with preference in the photothermographic material are organic halogen compounds. Examples of these are disclosed at paragraphs 0111 to 0112 in JP-A-11-65021. The organic polyhalogen compounds denoted by general formula (II) (specifically, tribromomethylnaphthylsulfone, tribromomethylphenylsulfone, and tribromomethyl(4-(2,4,6-trimethylphenylsulfonyl)phenyl)sulfone) in JP-A-10-339934 are preferred.

The methods described for the incorporation of reducing agents above are preferred examples of methods of incorporating antifogging agents into the photothermographic material. Organic polyhalogen compounds are also desirably added as solid microparticle dispersions. Further examples of antifogging agents are the mercury (II) salt of paragraph 0113, and the benzoic acid of paragraph 0114, of JP-A-11-65021. Azolium salts may also be employed as antifogging agents in the photothermographic material. Examples of azolium salts are the compounds denoted by general formula (XI) of JP-A-59-193447, the compounds described in JP-B-55-12581, and the compounds denoted by general formula (II) in JP-A-60-153039. Azolium salts may be added to any part of the photothermographic material, but are desirably added to the surface layer of the photosensitive layer, and preferably added to the organic silver salt-comprising layer. The azolium salt may be added during any step following the preparation of the coating liquid. When added to the organic silver salt-comprising layer, the azolium salt may be added during any step following the preparation of the organic silver salt to preparation of the coating liquid, with addition after the preparation of the organic silver salt to immediately prior to coating being preferred. The azolium salt may be added by any method in the form of a powder, solution, microparticles, or the like. Further, it may be added as a mixed solution with other additives such as sensitization dyes, reducing agents, and color toners. Any quantity of azolium salt may be added, but from 1×10⁻⁶ mol to 2 mol per mol of silver is desirable, with from 1×10⁻³ mol to 0.5 mol being preferred.

Mercapto compounds, disulfide compounds, and thione compounds may be incorporated to inhibit or promote development, control development, improve spectral sensitization efficiency, improve storage properties before and after development, and the like. These are described at paragraphs 0067 to 0069 in of JP-A-10-62899, in the description of the compounds denoted by general formula (I) and specifically at paragraphs 0033 to 0052 of JP-A-10-186572, and at lines 36-56, page 20 of European Patent Publication 0803764. Of these, mercapto-substituted heteroaromatic compounds are preferred.

Color toners are desirably added to the photothermographic material. Examples of color toners are described at paragraphs 0054 to 0055 in JP-A-10-62899, and lines 23-48, page 21, of European Patent Publication No. 0803764. The compounds of preference are: phthalazinone, phthalazinone derivatives and salts, 4-(1-naphthyl)phthalazinone, 6-chlorophthalazinone, 5,7-dimethoxyphthalazinone, 2,3-dihydro-1,4-phthalazinedione, and other derivatives; combinations with phthalazinone and phthalic acid derivatives (for example, phthalic acid, 4-methylphthalic acid, 4-nitrophthalic acid, and tetrachlorophthalic anhydride); phthalazines (phthalazine, phthalazine derivatives and salts, 4-(1-naphthyl)-phthalazine, 6-isopropylphthalazine, 6-t-butylphthalazine, 6-chlorophthalazine, 5,7-dimethoxyphthalazine, 2,3-dihydrophthalazine, and other derivatives); and combinations with phthalazines and phthalic acid derivatives (for example, phthalic acid, 4-methylphthalic acid, 4-nitrophthalic acid, and tetrachlorophthalic anhydride). Combinations with phthalazines and phthalic acid derivatives are preferred.

Plasticizers and lubricants suitable for use in the photosensitive layers of the photothermographic material are described at paragraph 0117 of JP-A-11-65021. Ultra-high contrast agents for forming an ultra-high contrast image are described at paragraph 0118 of the same and with regard to compounds of general formulas (III) to (V) (specifically, compounds 21 to 24) in JP-A-11-91652. Contrast promoting agents are described at paragraph 0102 of JP-A-11-65021.

A surface protecting layer can be provided in the photothermographic material to prevent adhesion of the image forming layer. Surface protective layers are described at paragraphs 0119 to 0120 in JP-A-11-65021. The use of gelatin or polyvinyl alcohol (PVA) as the binder in the surface protective layer is preferred. Examples of PVA are: fully saponified PVA-105 [PVA content of 94.0 weight percent or more, degree of saponification 98.5±0.5 molar percent, sodium acetate content 1.5 weight percent or less, volatile component 5.0 weight percent or less, viscosity (4 weight percent, 20° C.) 5.6±0.4 mPa·s], partially saponified PVA-205 [PVA content of 94.0 weight percent, degree of saponification 88.0±1.5 molar percent, sodium acetate content 1.0 weight percent, volatile component 5.0 weight percent, viscosity (4 weight percent, 20° C.) 5.0±0.4 mPa·s], and modified polyvinyl alcohols in the form of MP-102, MP-202, MP-203, R-1130, R-2105 (the above are names of products manufactured by Curare (K.K.)). The PVA coating quantity (per m² of support) of the protective layer (per layer) is desirably from 0.3 to 4.0 g/m², preferably from 0.3 to 2.0 g/m².

The preparation temperature of the coating liquid of the image forming layer is from 30 to 65° C., preferably greater than or equal to 35° C. and less than 60° C., more preferably from 35 to 55° C. Further, the temperature of the coating liquid of the image forming layer immediately following addition of the polymer latex is desirably maintained at from 30 to 65° C. Further, the reducing agent and organic silver salt are desirably admixed prior to addition of the polymer latex. The organic silver salt-containing fluid or the coating liquid of the thermal image forming layer is desirably a thixotropic liquid. Thixotropy refers to a property whereby a decrease in viscosity accompanies an increase in the shear rate. Any device may be employed to measure viscosity. However, the RFS Fluid Spectrometer manufactured by Rheometrix Far East (Ltd.) is desirably used to take measurements at 25° C. Here, the viscosity at a shear rate of 0.1 S⁻¹ of the organic silver salt-containing fluid or the coating liquid of the thermal image forming layer is desirably from 400 to 100,000 Pa·s, preferably from 500 to 20,000 mPa·s. A viscosity of from 1 to 200 mPa·s is desirable at a shear rate of 1,000 S⁻¹, with from 5 to 80 mPa·s being preferred.

Various systems exhibiting thixotropy are known. These are described in “Lectures on Rheology”, ed. by the Macromolecular Publishing House; “High Polymer Latex”, coauthored by Muroi and Morino (pub. by Macromolecular Publishing House), and the like. A liquid must contain numerous solid microparticles to exhibit thixotropy. Further, thixotropy can be effectively increased by incorporating thickening linear macromolecules, increasing the aspect ratio through the anisotropy of the solid microparticles contained, or by using alkali thickeners or surfactants.

The emulsion may be configured of one or more layers on a support. A single-layer configuration necessarily comprises an organic silver salt, a silver halide, a developer, and a binder, as well as desired added materials such as color toners, coating adjuvants, and other adjuvants. A two-layer configuration necessarily comprises an organic silver salt and silver halide in the first emulsion layer (normally, the layer adjacent to the support), and a number of other components in the second layer. However, a two-layer configuration is also conceivable in which all components are comprised in a single emulsion layer, with the second layer comprised of a protective top coat. In configurations with multicolor photothermographic materials, these two-layer combinations are incorporated for each color. Further, all components may be contained in a single layer such as is described in U.S. Pat. No. 4,708,928. In the case of multidye, multicolor photothermographic materials, each emulsion layer is generally maintained separate from the others by means of a functional or nonfunctional barrier layer between each photosensitive layer, such as described in U.S. Pat. No. 4,460,681.

To enhance tone, prevent the generation of interference fringes when conducting laser exposure, and prevent irradiation, various dyes and pigments may be employed in the photosensitive layer. These are described in detail in International Publication WO98/36322. Preferred dyes and pigments for use in photosensitive layers are anthraquinone dyes, azomethine dyes, indaniline dyes, azo dyes, anthraquinone-based indanthrone pigments (such as C.I. Pigment Blue 60), phthalocyanine pigments (copper phthalocyanine such as C.I. Pigment Blue 15 and nonmetallic phthalocyanines such as C.I. Pigment Blue 16), and lake pigments with dyes such as triarylcarbonyl pigments, indigo, and inorganic dyes (ultramarine, cobalt blue, and the like). These dyes and pigments may be added by any method, such as in solutions, emulsions, solid particle dispersions, and high polymer mordents. The quantity of these compounds employed is determined by the targeted amount of absorption. However, a quantity falling within a range of from 1 microgram to 1 gram per m² of photothermographic material is generally employed.

An antihalation layer may be provided on the side of the photosensitive layer farthest from the light source. Antihalation layers are described at paragraphs 0123 and 0124 in JP-A-11-65021. Color eliminating dyes and base precursors are desirably added to the non-photosensitive layers of the photothermographic layer, causing the non-photosensitive layers to function as filter layers or antihalation layers. Generally, the photothermographic material comprises non-photosensitive layers in addition to photosensitive layers. Based on position, non-photosensitive layers may be classified as (1) protective layers provided on photosensitive layers (on the far side from the support), (2) intermediate layers provided between multiple photosensitive layers or between a photosensitive layer and a protective layer, (3) undercoating layers provided between a photosensitive layer and the support, and (4) back layers provided on the opposite side from photosensitive layers. Filter layers are provided in photothermographic materials as layer (1) or (2). Antihalation layers are provided in photothermographic materials as layer (3) or (4).

Color eliminating dyes and base precursors are desirably added in the same non-photosensitive layer. However, they may also be separately added to two adjacent non-photosensitive layers. Further, a barrier layer may be provided between two non-photosensitive layers. Color eliminating dyes are added to non-photosensitive layers by adding a solution, emulsion, solid microparticle dispersion, or polymer impregnated product to the coating liquid of the non-photosensitive layer. It is also possible to use a polymer mordant to add a dye to a non-photosensitive layer. These methods of addition are identical to the common methods of adding dyes to photothermographic materials. Latexes employed in polymer impregnated products are described in U.S. Pat. No. 4,199,363, West German Patent Publication Nos. 25141274 and 2541230, European Patent Publication No. 029104, and JP-B-53-41091. An emulsification method of adding a dye to a solution of dissolved polymer is described in International Publication WO88/00723.

The quantity of color eliminating dye added is determined by the dye application. Generally, a quantity is employed so that the optical density (absorbance) exceeds 0.1 when measured at the targeted wavelength. The optical density is desirably from 0.2 to 2. The quantity of dye added to achieve such an optical density is generally about from 0.001 to 1 g/m², preferably from about 0.01 to 0.2 g/m². When such a dye is eliminated, it is possible to reduce the optical density to less than or equal to 0.1. Two or more color eliminating dyes may be employed in combination in thermal color-eliminating recording materials and photothermographic materials. Similarly, two or more base precursors may be employed in combination. Photothermographic materials are desirably single-sided photosensitive materials, having at least one photosensitive layer comprising a silver halide emulsion on one side of the support and a back layer on the other side.

Matting agents are desirably added to photothermographic materials to improve carrying properties. Matting agents are described at paragraphs 0126 to 0127 in JP-A-11-65021. Expressed as a coating quantity per m² of photothermographic material, matting agents are desirably applied to from 1 to 400 mg/m², preferably from 5 to 300 mg/m². Further, any degree of matting of the emulsion surface that does not produce a starry effect is adequate. However, a Beck smoothness of greater than or equal to 30 sec and less than or equal to 2,000 sec is desirable, with greater than or equal to 40 sec and less than or equal to 1,500 sec being preferred. The degree of matting of the back layer is such that the Beck smoothness is greater than or equal to 10 sec and less than or equal to 1,200, with a degree of matting greater than or equal to 20 sec and less than or equal to 800 sec being desirable and greater than or equal to 40 sec and less than or equal to 500 sec being preferred. The matting agent is incorporated into the outermost layer of the photothermographic material, the layer functioning as the outermost layer, a layer close to the outermost surface, or the layer functioning as the protective layer. Paragraphs 0128 to 0130 in JP-A-11-65021 describe back layers capable of being employed in photothermographic materials.

Film hardeners may be employed in various layers, such as photosensitive layers, protective layers, and back layers. Examples of film hardeners are described at pages 77 to 87 in T. H. James, “The Theory of the Photographic Process, Fourth Edition” (Macmillan Publishing Co., Inc., 1977). The polyvalent metal ions described in this treatise at page 78; the polyisocyanates described in U.S. Pat. No. 4,281,060 and JP-A-6-208193; the epoxy compounds described in U.S. Pat. No. 4,791,042; and the vinyl sulfone-based compounds described in JP-A-62-89048 are desirably employed.

Film hardeners are added as solutions. The solution is added to the protective layer coating liquid from 180 min to immediately before coating, preferably from 60 min to 10 sec before coating. The mixing method and mixing conditions are not specifically limited. Specific methods of mixing include the method of mixing in a tank so as to achieve a desired average retention time calculated from the addition flow rate and the amount of liquid fed to the coater, and the method employing a static mixer described in Chapter 8 of “Liquid Mixing Techniques” by N. Harnby, M. F. Edwards, and A. W. Nienow, translated by K. Takahashi (published by Nikkan Kogyo Shinbunsha, 1989).

Surfactants are described at paragraph 0132 in JP-A-11-65021. Solvents are described at paragraph 0133 of the same. Supports are described at paragraph 0134 of the same. Static preventing and conductive layers are described at paragraph 0135 of the same. And methods of obtaining color images are described at paragraph 0136 of the same. A transparent support may be dyed with a blue dye (for example, Dye 1 described in the embodiments of JP-A-8-240877) or left transparent. Support undercoating techniques are described in JP-A-11-84574 and JP-A-10-186565. The antistatic layer and undercoating techniques described in JP-A-56-143430, JP-A-56-143431, JP-A-58-62646, and JP-A-56-120519 may be employed.

The photothermographic material is desirably in the form of a monosheet (capable of forming an image on the photothermographic material without the use of another sheet such as an image-receiving material). Oxidation inhibitors, stabilizers, plasticizers, UV absorbents, and coating adjuvants may be added to the photothermographic material. The various additives may be added to both photosensitive layers and non-photosensitive layers. In regard to such additives, reference may be made to International Publication WO98/36322, European Patent Publication 803764, and JP-A-10-186567 and JP-A-10-18568.

The photosensitive layers further desirably comprise ultra-high contrast agents. Ultra-high contrast agents may also be incorporated into non-photosensitive layers. When photothermographic materials are employed in the area of printing-use photography, the reproduction of halftone-based continuous gradient images and line images is important. The use of ultra-high contrast agents improves the reproducibility of halftone images and line images. Ultra-high contrast agents in the form of hydrazine compounds, quaternary ammonium compound, and acrylonitrile compounds (described in U.S. Pat. No. 5,545,515) may be employed. Hydrazine compounds are the ultra-high contrast agents of preference.

Hydrazine compounds include hydrazine (H₂N—NH₂) and compounds in which at least one of the hydrogen atoms of hydrazine has been substituted. The substituent may be an aliphatic group, aromatic group, or heterocyclic group directly bonded to one of the nitrogen atoms of hydrazine, or may be an aliphatic group, aromatic group, or heterocyclic group bonded through a connecting group to one of the nitrogen atoms of hydrazine. Examples of connecting groups are —CO—, —CS—, —SO₂—, —POR— (where R denotes an aliphatic group, aromatic group, or heterocyclic group), —CNH—, or some combination thereof. Hydrazine compounds are described in U.S. Pat. Nos. 5,464,738, 5,496,695, 5,512,411, and 5,536,622; JP-B-6-77138 and JP-B-6-93082; and JP-A-6-230497, JP-A-6-289520, JP-A-6-313951, JP-A-7-5610, JP-A-7-77783, and JP-A-7-104426.

Hydrazine compounds may be dissolved in suitable organic solvents and added to the coating liquid of the photosensitive layer. Examples of organic solvents are: alcohols (for example, methanol, ethanol, propanol, fluorinated alcohol); ketones (for example, acetone and methyl ethyl ketone), dimethylformamide; dimethylsulfoxide; and methyl cellosolve. Hydrazine compounds may be dissolved in an oil-based (adjuvant) solvent to obtain a solution that is emulsified into the coating liquid. Examples of oil-based (adjuvant) solvents are dibutyl phthalate, tricresyl phosphate, glyceryl triacetate, diethyl phthalate, ethyl acetate, and cyclohexanone. The solid dispersion of a hydrazine compound may be added to the coating liquid. Hydrazine compounds may be dispersed in known dispersing devices such as ball mills, colloid mills, Manton-Goring, micro-fluidizers, and ultrasonic dispersing devices.

The quantity of ultra-high contrast agent added is desirably from 1×10⁻⁶ to 1×10⁻² mol, preferably from 1×10⁻⁵ to 5×10⁻³ mol, and more preferably from 2×10⁻⁵ to 5×10⁻³ mol, per mol of silver halide. In addition to ultra-high contrast agents, contrast promoting agents may also be employed. Examples of contrast promoting agents are amine compounds (described in U.S. Pat. No. 5,545,505), hydroxamic acid (U.S. Pat. No. 5,545,507), acrylonitriles (U.S. Pat. No. 5,545,507), and hydrazine compounds (U.S. Pat. No. 5,558,983).

The photothermographic material may be exposed by any method, but a laser beam is the exposure light source of preference. Preferred laser beams are: gas lasers (Ar⁺, He—Ne), YAG laser, pigment lasers, and semiconductor lasers. Semiconductor lasers may be used in conjunction with a second high-frequency generating element. A red-to-infrared emitting gas or semiconductor laser is preferred. The laser beam may be in the form of a single-mode laser, and the technique described in JP-A-11-65021 may be employed. The laser output is desirably greater than or equal to 1 mW, with an output of greater than or equal to 10 mW being preferred and a high output of greater than or equal to 40 mW being of even greater preference. In this process, multiple lasers may be combined. The diameter of the laser beam can be made about 30 to 200 micrometers, or 1/e² the spot size of a Gaussian beam. An example of a laser imager equipped with exposure element and heat-developing element is the Fuji Medical Dry Laser Imager FM-DPL.

The photothermographic material forms a black-and-white image based on a silver image, and is desirably employed as a photothermographic material for medical diagnosis, a photothermographic material for industrial photography, a photothermographic material for printing, or a photothermographic material for COM. In these uses, based on the formation of black and white images, the heat developed photosensitive material may be employed as a mask in medical diagnosis when forming a duplicate image on duplication-use film MI-Dup manufactured by Fuji Photo Film Co. (Ltd.) and when forming images on restoration film DO-175 and PDO-100 manufactured by Fuji Photo Film Co. (Ltd.) for printing, and offset printing plates.

Next, heat-sensitive recording materials will be described. The heat-sensitive recording materials are conventional sheet recording materials that can be packed in the packing material of the present invention.

The heat-sensitive recording material has a heat-sensitive recording layer and a protective layer on a support. The heat-sensitive recording material may have other layers if necessary.

When the heat-sensitive recording material has an intermediate layer, the protective layer is formed on the intermediate layer.

Next, heat-sensitive recording materials will be described. The heat-sensitive recording materials are conventional sheet recording materials that can be packed in the packing of the present invention.

The heat-sensitive recording material has a heat-sensitive recording layer and a protective layer on a support. The heat-sensitive recording material may have other layers if necessary. When the heat-sensitive recording material has an intermediate layer, the protective layer is formed on the intermediate layer. The protective layer is formed by applying a coating solution for the protective layer. The coating solution for the protective layer contains at least a pigment and a binder. Further, in order to improve head matching performance and to obtain an excellent coated surface, the coating solution for the protective layer contains an emulsion of silicone oil, which is dispersed so that the average particle diameter thereof is 0.15 μm or less (the dispersed silicone oil will be occasionally simply referred to as the “silicone oil”, hereinafter). The coating solution for the protective layer contains other components if necessary.

While the silicone oil used in the present invention is dispersed so that the average particle diameter thereof is 0.15 μm or less, the average particle diameter is preferably 0.10 μm or less, and more preferably 0.08 μm or less. If the average particle diameter exceeds 0.15 μm, the emulsion of the silicone oil is damaged by strong stirring or ultrasonic irradiation, and huge oil droplets are formed. Accordingly, coating defects due to repelling may be caused easily. In the present invention, the average particle diameter of the silicone oil is indicated by values measured by a submicron particle analyzer (N-4-type, manufactured by Coulter, Inc.). The silicone oil used in the present invention is not particularly limited as long as the silicone oil is dispersed so that the average particle diameter thereof is 0.15 μm or less, and commercially available products may be used. Silicone oil whose average particle diameter exceeds 0.15 μm can also be used in the present invention by dispersing the silicone oil thoroughly so that the average particle diameter becomes 0.15 μm or less.

In order to disperse the silicone oil such that the average particle diameter thereof becomes 0.15 μm or less, a conventional dispersing machine such as a homogenizer, a dissolver, a colloid mill, or an ultrasonic emulsifier is used in the presence of an auxiliary dispersant such as polyvinyl alcohol or any of various types of surfactants, preferably a nonionic surfactant or alkylbenzene sulfonate. In such a manner, the silicone oil can be dispersed such that the average particle diameter thereof is within the above-described range.

While an ordinary polydimethylsiloxane can be used for the silicone oil, ether modified silicone oil, carboxy modified silicone oil, amino modified silicone oil, carbinol modified silicone oil, phenol modified silicone oil, and mercapto modified silicone oil are preferable, and ether modified silicone oil, carboxy modified silicone oil, and amino modified silicone oil are more preferable. A single type of silicone oil or a combination of two or more types of silicone oils may be used. These modified silicone oils may be modified at the side chain or at the terminal of the molecule.

The viscosity of the silicone oil used in the present invention is preferably 400 to 100,000 cps, and more preferably 1,000 to 50,000 cps. If the viscosity is lower than 400 cps, the surface of the protective layer feels sticky to the touch, and fingerprints may be left when the surface is touched by fingers. On the other hand, if the viscosity exceeds 100,000 cps, it is difficult to emulsify and disperse the silicone oil to the extent that an average particle diameter of 0.15 μm or less is achieved.

The added amount of the silicone oil used in the present invention is preferably 1 to 15% by weight and more preferably 2 to 10% by weight based on the total coating amount of the protective layer. If the added amount is less than 1% by weight, it may not be possible to obtain the effect of providing lubricating property with respect to the head. On the other hand, if the added amount exceeds 15% by weight, further effects may not be expected. Besides, ill effects such as fouling on the head might be caused.

The pigment is generally used to enable recording by a thermal head to be carried out better. Specifically, the pigment is used to reduce sticking and generation of noise and the like It is preferable that an organic and/or inorganic pigment is used.

It is preferable that the pigment used in the protective layer is a pigment in which 50% by volume of the total volume of particles in the pigment is particles having a volume average particle diameter of 0.20 to 1.00 μm. This “50% volume average particle diameter” thus refers to the average diameter of 50% by volume of all of the particles of the pigment, and is measured by an apparatus for measuring distribution of particle diameters by laser diffraction, LA700, manufactured by Horiba Ltd. Hereinafter, the average particle diameter of 50% by volume of the total volume of the particles will upon occasion be simply referred to as the “average particle diameter”. It is more preferable that the 50% volume average particle diameter of the pigment is in a range of 0.20 to 0.50 μm to prevent sticking and generation of noise and the like between a thermal head and the heat-sensitive recording material during recording by using the thermal head.

When the 50% volume average particle diameter of the particles exceed 1.00 μm, the effect of reducing wear of a thermal head decreases. When the 50% volume average particle diameter is less than 0.20 μm, the effect of addition of the pigment, i.e., the effect of preventing adhesion caused by the binder in the protective layer fusing to the thermal head, decreases, and, as a result, so-called sticking, i.e., adhesion of the protective layer of the heat-sensitive recording material to the thermal head, takes place during printing. Therefore, such average particle diameters are not preferable.

The pigment contained in the protective layer is not particularly limited and conventional organic and inorganic pigments can be used. Preferable examples of the pigment include inorganic pigments such as calcium carbonate, titanium oxide, kaolin, aluminum hydroxide, amorphous silica and zinc oxide; and organic pigments such as urea-formaldehyde resins and epoxy resins. Among these pigments, kaolin, aluminum hydroxide and amorphous silica are more preferable. A single type of the pigment or a combination of two or more types of the pigments may be used.

Particularly preferable examples among these pigments include inorganic pigments obtained by coating the surface of the pigment particle with at least one type of compound selected from the group consisting of higher fatty acids, metal salts of higher fatty acids, higher alcohol, and amides of higher fatty acids.

Examples of the higher fatty acids include stearic acid, palmitic acid, myristic acid, lauric acid and the like.

These pigments are preferably dispersed by a conventional dispersing machine such as a dissolver, a sand mill, or a ball mill in the presence of an auxiliary dispersant such as sodium hexametaphosphate, partially or fully saponified modified polyvinyl alcohol, copolymers of polyacrylic acid, and various types of surfactants, preferably a partially or fully saponified modified polyvinyl alcohol or an ammonium salt of a copolymer of polyacrylic acid in such a manner that the average particle diameter has the above-described value, and then used. That is, it is preferable that the pigment is dispersed before use such that the 50% volume average particle diameter of the pigment particles is in the range of 0.20 to 1.00 μm.

To achieve excellent transparency, it is preferable that fully saponified polyvinyl alcohol, carboxy modified polyvinyl alcohol, silica modified polyvinyl alcohol or the like is used as the binder for the protective layer.

The protective layer may contain conventional film hardeners, metal soaps, and the like.

To form a uniform protective layer on the heat-sensitive recording layer, or on the intermediate layer, it is preferable that a surfactant is added to a coating solution for forming the protective layer. Examples of the surfactant include alkali metal salts of sulfosuccinic acid and fluorine-containing surfactants and the like. Specific examples of the surfactant include sodium salts or ammonium salts of di-(2-ethylhexyl) sulfosuccinate, di-(n-hexyl) sulfosuccinate and the like.

Further, to the protective layer, waxes may be added to reduce wear of a recording head, and surfactants, fine particles of metal oxides, inorganic electrolytes, macromolecular electrolytes and the like may be added to prevent electrostatic charge on the heat-sensitive recording material.

The wax preferably has a melting point in the range of 40 to 100° C. and a 50% volume average particle diameter of 0.7 μm or less and more preferably of 0.4 μm or less.

When the average particle diameter exceeds 0.7 μm, transparency of the protective layer deteriorates or obtained images do not come out clearly. Therefore, such a diameter is not preferable.

When the melting point is lower than 40° C., the surface of the protective layer becomes tacky. When the melting point exceeds 100° C., sticking tends to take place. Therefore, such melting points are not preferable.

As the wax having a melting point of 40° C. to 100° C., petroleum waxes such as paraffin wax and microcrystalline wax, synthetic waxes such as polyethylene wax, plant waxes such as candelilla wax, carnauba wax and rice wax, animal waxes such as lanolin, and mineral waxes such as montan wax, can be used. Among these waxes, paraffin wax having a melting point of 55 to 75° C. is particularly preferable.

The wax is preferably used in an amount of 0.5 to 40% by weight and more preferably in an amount of 1 to 20% by weight of the total amount of the protective layer. The wax may be used in combination with derivatives of 12-hydroxystearic acid, higher fatty acid amides, or the like.

To obtain a dispersion of the wax having the above-described 50% volume average particle diameter, the wax may be dispersed by using a conventional wet type dispersing machine such as a dyno mill and a sand mill in the presence of a suitable protective colloid and/or a suitable surfactant. A method in which the wax is heated to melt and then emulsified by stirring at a high speed or by ultrasonic dispersion in a solvent in which the wax is insoluble or slightly soluble at a temperature not lower than the melting point of the wax, or a method in which the wax is dissolved in a suitable solvent and then emulsified in a solvent in which the wax is insoluble or slightly soluble, can also be used to obtain a dispersion having small particles. A suitable surfactant or a suitable protective colloid may be used in combination in the above methods.

The protective layer may have a single layer structure or a laminate structure having two or more layers. The coated amount of the dried protective layer is preferably 0.2 to 7 g/m² and more preferably 1 to 4 g/m².

The heat-sensitive recording layer contains at least a color forming component, and other components if necessary.

The heat-sensitive recording layer may have any composition as long as the layer has excellent transparency before color development and develops color by heating.

Examples of the heat-sensitive recording layer include a so-called two-component heat-sensitive recording layer containing a naturally colorless color forming component A and a naturally colorless color forming component B which forms color by reaction with the color forming component A. It is preferable that either one of the color forming components A and B is micro-encapsulated. Examples of combinations of two components constituting the two-component heat-sensitive recording layer include the following combinations (a) to (m):

(a) Combinations of electron-donating dye precursors with electron-accepting compounds.

(b) Combinations of photodecomposable diazo compounds with couplers.

(c) Combinations of organic metal salts such as silver behenate and silver stearate with reducing agents such as protocatechuic acid, spiroindane and hydroquinone.

(d) Combinations of long chain aliphatic salts such as ferric stearate and ferric myristate with phenols such as gallic acid and ammonium salicylate.

(e) Combinations of heavy metal salts of organic acids such as nickel, cobalt, lead, copper, iron, mercury or silver salt of acetic acid, stearic acid and palmitic acid with alkaline earth metal sulfides such as calcium sulfide, strontium sulfide and potassium sulfide, or combinations of the above heavy metal salts of organic acids with organic chelating agents such as s-diphenylcarbazide and diphenylcarbazone.

(f) Combinations of (heavy) metal sulfates such as silver sulfide, lead sulfide, mercury sulfide and sodium sulfide with sulfur compounds such as sodium tetrathionate, sodium thiosulfate and thiourea.

(g) Combinations of aliphatic ferric salts such as ferric stearate with aromatic polyhydroxy compounds such as 3,4-dihydroxytetraphenylmethane.

(h) Combinations of organic noble metal salts such as silver oxalate and mercury oxalate with organic polyhydroxy compounds such as polyhydroxyalcohol, glycerin and glycol.

(i) Combinations of aliphatic ferric salts such as ferric peralgonate and ferric laurate with derivatives of thiocetylcarbamide and isothiocetylcarbamide.

(j) Combinations of lead salts of organic acids such as lead capronate, lead peralgonate and lead behenate with derivatives of thiourea such as ethylenethiourea and N-dodecylthiourea.

(k) Combinations of heavy metal salts of higher fatty acids such as ferric stearate and copper stearate with zinc dialkyldithiocarbamate.

(l) Forming oxazine dyes such as combination of resorcinol and nitroso compounds.

(m) Combinations of formazane compounds with reducing agents and/or metal salts.

In the heat-sensitive recording material, the combinations (a) of electron-donating dye precursors with electron-accepting compounds, combinations (b) of photodecomposable diazo compounds with couplers, or combinations (c) of organic metal salts with reducing agents are preferable. The combinations (a) of electron-donating dye precursors with electron-accepting compounds and the combinations (b) of photodecomposable diazo compounds with couplers are particularly preferable.

In the heat-sensitive recording material, images having excellent transparency can be obtained by forming a heat-sensitive recording layer so as to have a decreased haze value which is obtained from the calculation: (diffused light transmittance/total light transmittance)×100(%).

The haze value is an index showing the transparency of a material and is generally calculated from the total light transmittance, the diffused light transmittance and the specular light transmittance obtained by using a haze meter.

In the present invention, the haze value can be decreased by a method in which the volume average particle diameter of 50% by volume of each of color forming components A and B contained in the heat-sensitive recording layer is adjusted to 1.0 μm or less and preferably to 0.6 μm or less and a binder is contained in an amount in the range of 30 to 60% by weight of the total solid components of the heat-sensitive recording layer, or by a method in which one of the color forming components A and B is micro-encapsulated and the other is used in a form which forms a substantially continuous layer after application and drying, for example, is used in the form of an emulsion.

It is also effective if the refractivity indices of the components used in the heat-sensitive recording layer are adjusted to be as close to a specific value as possible.

The combinations (a), (b) and (c) which are preferably used in the heat-sensitive recording layer are described in detail hereinafter.

(a) The heat-sensitive recording layer using the combination of an electron-donating dye precursor and an electron-accepting compound is described hereinafter.

The electron-donating dye precursor preferably used in the present invention is not particularly limited as long as the precursor is naturally colorless. The electron-donating dye precursor is a compound having the property of developing color by donating an electron or by accepting a proton from an acid or the like. A colorless compound having a partial skeleton structure of lactone, lactum, sultone, spiropyran, ester or amide which causes an open ring or cleavage of the structure when the compound is brought into contact with an electron-accepting compound is preferably used.

Examples of the electron-donating dye precursor include triphenylmethane phthalide compounds, fluoran compounds, phenothiazine compounds, indolyl phthalide compounds, leuko auramine compounds, rhodamine lactum compounds, triphenylmethane compounds, triazine compounds, spiropyran compounds, fluorene compounds, pyridine compounds and pyrazine compounds.

Specific examples of the phthalide compound include compounds described in U.S. Reissued Pat. No. 23,024 and U.S. Pat. Nos. 3,491,111, 3,491,112, 3,491,116 and 3,509,174.

Specific examples of the fluoran compound include compounds described in U.S. Pat. Nos. 3,624,107, 3,627,787, 3,641,011, 3,462,828, 3,681,390, 3,920,510 and 3,959,571.

Specific examples of the spiropyran compounds include compounds described in U.S. Pat. No. 3,971,808.

Specific examples of the pyridine compound and the pyrazine compound include compounds described in U.S. Pat. Nos. 3,775,424, 3,853,869 and 4,246,318.

Specific examples of the fluorene compound include compounds described in Japanese Patent Application No. 61-240989.

In particular, 2-arylamino-3-[H, halogen, alkyl or alkoxy-6-substituted aminofluorans] which form black color are preferable among the above compounds.

Specific examples of the above compound include 2-anilino-3-methyl-6-diethylaminofluoran, 2-anilino-3-methyl-6-N-cyclohexyl-N-methylaminofluoran, 2-p-chloroanilino-3-methyl-6-dibutylaminofluoran, 2-anilino-3-methyl-6-dioctylaminofluoran, 2-anilino-3-chloro-6-diethylaminofluoran, 2-anilino-3-methyl-6-N-ethyl-N-isoamylaminofluoran, 2-anilino-3-methyl-6-N-ethyl-N-dodecylaminofluoran, 2-anilino-3-methoxy-6-dibutylaminofluoran, 2-o-chloroanilino-6-dibutylaminofluoran, 2-p-chloroanilino-3-ethyl-6-N-ethyl-N-isoamylaminofluoran, 2-o-chloroanilino-6-p-butylanilinofluoran, 2-anilino-3-pentadecyl-6-diethylaminofluoran, 2-anilino-3-ethyl-6-dibutylaminofluoran, 2-o-toluidino-3-methyl-6-diisopropylaminofluoran, 2-anilino-3-methyl-6-N-isobutyl-N-ethylaminofluoran, 2-anilino-3-methyl-6-N-ethyl-N-tetrahydrofurfurylaminofluoran, 2-anilino-3-chloro-6-N-ethyl-N-isoamylaminofluoran, 2-anilino-3-methyl-6-N-methyl-N-γ-ethoxypropylaminofluoran, 2-anilino-3-methyl-6-N-ethyl-N-γ-ethoxypropylaminofluoran, and 2-anilino-3-methyl-6-N-ethyl-N-γ-propoxypropylaminofluoran.

Examples of the electron-accepting compound which interacts with the electron-donating dye precursor include acidic substances such as phenol compounds, organic acids, metal salts of organic acids, and esters of oxybenzoic acid, for example, the compounds described in JP-A-61-291183.

Specific examples of the electron-accepting compound include: bisphenols such as 2,2-bis(4′-hydroxyphenyl)-propane (generic name.: bisphenol A), 2,2-bis(4′-hydroxyphenyl)pentane, 2,2-bis(4′-hydroxy-3′,5′-dichlorophenyl)-propane, 1,1-bis(4′-hydroxyphenyl)cyclohexane, 2,2-bis-(4′-hydroxyphenyl)hexane, 1,1-bis(4′-hydroxyphenyl)-propane, 1,1-bis(4′-hydroxyphenyl)butane, 1,1-bis(4′-hydroxyphenyl)pentane, 1,1-bis(4,hydroxyphenyl)hexane, 1,1-bis(4′-hydroxyphenyl)heptane, 1,1-bis(4′-hydroxyphenyl)octane, 1,1-bis(4′-hydroxyphenyl)-2-methyl-pentane, 1,1-bis(4′-hydroxyphenyl)-2-ethyl-hexane, 1,1-bis(4′-hydroxyphenyl)dodecane, 1,4-bis(p-hydroxyphenylcumyl)-benzene, 1,3-bis(p-hydroxyphenylcumyl)benzene, bis(p-hydroxyphenyl)sulfone, bis(3-allyl-4-hydroxyphenyl)-sulfone and benzyl bis(p-hydroxyphenyl)acetate; derivatives of salicylic acid such as 3,5-di-α-methylbenzylsalicylic acid, 3,5-di-tert-butylsalicylic acid, 3-α,α-dimethylbenzylsalicylic acid and 4-(β-p-methoxyphenoxyethoxy)salicylic acid; salts of the derivatives of salicylic acid with multivalent metals (particularly zinc and aluminum); esters of oxybenzoic acid such as benzyl p-hydroxy benzoate, 2-ethylhexyl p-hydroxybenzoate, 2-phenoxyethyl β-resorcylate; and phenols such as p-phenylphenol, 3,5-diphenylphenol, cumylphenol, 4-hydroxy-4′-isopropoxy-diphenylsulfone and 4-hydroxy-4′-phenoxy-diphenylsulfone.

Bisphenols are preferable among these compounds from the standpoint of obtaining an excellent color developing property.

A single type or a combination of two or more types of the above electron-accepting compounds may be used.

(b) The combination of a photodecomposable diazo compound and a coupler is described hereinafter.

The photodecomposable diazo compound develops a desired color by the coupling reaction with a coupler which is a coupling component described later. When light having a wavelength of a specific range is irradiated onto the photodecomposable diazo compound before the coupling reaction, the photodecomposable diazo compound is decomposed and loses the ability to develop color even in the presence of the coupling component.

The color hue of this coloring system is decided by the diazo dye produced by the reaction of the diazo compound with the coupler. Therefore, the developed hue can be changed easily by changing the chemical structure of the diazo compound or the coupler. Thus, a desired hue can be obtained by selecting a suitable combination of the diazo compound and the coupler.

As the photodecomposable diazo compound used in the present invention, aromatic diazo compounds are preferable. Specifically, aromatic diazonium salts, diazosulfonate compounds and diazoamino compounds are preferable.

The aromatic diazonium salt may be a compound represented by the following formula:

Ar—N₂⁺ X⁻

wherein Ar represents a substituted or unsubstituted aromatic hydrocarbon ring group, N₂⁺ represents a diazonium group and X⁻ represents an acid anion. However, the aromatic diazonium compound is not particularly limited thereto. Aromatic diazonium compounds which exhibit an excellent photofixing property, cause little color stains after fixing and form a stable color developed portion are preferably used.

Many diazosulfonate compounds have come to be known recently and can be obtained by treating corresponding diazonium salts with a sulfite. These compounds are advantageously used in the heat-sensitive recording material.

The diazoamino compound can be obtained by coupling a diazo group with dicyandiamide, sarcosine, methyltaurine, N-ethylanthranic acid-5-sulfonic acid, monoethanolamine, diethanolamine or guanidine, and is advantageously used in the heat-sensitive recording material.

These diazo compounds are described in detail, for example, in JP-A 2-136286.

Examples of the coupler which is used for the coupling reaction with the above diazo compound include 2-hydroxy-3-naphthoic acid anilide, resorcinol and other compounds described in JP-A 62-146678 and the like.

When the diazo compound and the coupler are used in combination in the heat-sensitive recording layer, a basic substance may be added as the sensitizer to accelerate the reaction by carrying out the coupling reaction in a basic atmosphere.

As the basic substance, a basic substance which is insoluble or slightly soluble in water or which generates an alkali upon heating can be used. Examples of the basic substance include compounds containing nitrogen such as inorganic or organic ammonium salts, organic amines, amides, urea, thiourea, derivatives of urea and thiourea, thiazoles, pyrrols, pyrimidines, piperazines, guanidines, indols, imidazoles, imidazolines, triazoles, morpholines, piperidines, amidines, formazines and pyridines.

Specific examples of these compounds include compounds described in JP-A 61-291183.

(c) The combination of an organic metal salt and a reducing agent is described hereinafter.

Specific examples of the organic metal salt include silver salts of long chain aliphatic carboxylic acids such as silver laurate, silver myristate, silver palmitate, silver stearate, silver arachate and silver behenate; silver salts of organic compounds having imino group such as silver salt of benzotriazole, silver salt of benzimidazole, silver salt of cabazole and silver salt of phthaladinone; silver salts of compounds containing sulfur such as s-alkyl thioglycolates; silver salts of aromatic carboxylic acids such as silver benzoate and silver phthalate; silver salts of sulfonic acids such as silver ethanesulfonate; silver salts of sulfinic acids such as silver o-toluenesulfinate; silver salts of phosphoric acids such as silver phenylphosphate; silver barbiturate; silver saccharinate; silver salt of salicylaldoxime; and mixtures of these compounds.

Among these compounds, silver salts of long chain aliphatic carboxylic acids are preferable and silver behenate is more preferable. Behenic acid may be used in combination with silver behenate.

As the reducing agent, suitable compounds may be used with reference to the descriptions from the 14th line in the lower left column of page 227 to the 11th line in the upper right column of page 229 in the specification of JP-A 53-1020. Among such compounds, mono-, bis-, tris- and tetrakis-phenols, mono- and bis-naphthols, di- and polyhydroxy-naphtalenes, di- and polyhydroxybenzenes, hydroxymonoethers, ascorbic acids, 3-pyrazolidones, pyrazolines, pyrazolones, reducing sugars, phenylenediamines, hydroxylamines, reductons, hydroxamines, hydrazides, amidoximes and N-hydroxyureas are preferably used.

Among these compounds, aromatic organic reducing agents such as polyphenols, sulfonamidophenols and naphthols are more preferable.

To surely achieve sufficient transparency of the heat-sensitive recording material, it is preferable that the combination (a) of an electron-donating dye precursor and an electron-accepting compound or the combination (b) of a photodecomposable diazo compound and a coupler is used for the heat-sensitive recording layer. It is also preferable that either one of the color forming components A and B is used in the form of microcapsules, and it is more preferable that the electron-donating dye precursor or the photodecomposable diazo compound is used in the form of microcapsules.

The method for producing microcapsules is described in detail hereinafter.

Microcapsules can be produced by interfacial polymerization, internal polymerization, external polymerization or the like, and any of these methods can be used.

As described above, it is preferable that the electron-donating dye precursor or the photodecomposable diazo compound is micro-encapsulated for the heat-sensitive recording material. In particular, interfacial polymerization is preferable. Interfacial polymerization is carried out as follows: an oil phase is prepared by dissolving or dispersing the electron-donating dye precursor or the photodecoposable diazo compound, which forms the core of the capsule, in a hydrophobic organic solvent; the prepared oil phase is mixed with an aqueous phase in which a water-soluble polymer is dissolved; the two phases are emulsified and dispersed with each other by a device such as a homogenizer; a polymer substance is formed at the interface of the oil droplets by the reaction induced by heating; and the walls of microcapsules of the polymer are formed.

The reactants for forming the polymer substance are added to the inside and/or the outside of the oil droplets. Specific examples of the polymer substance include polyurethanes, polyureas, polyamides, polyesters, polycarbonates, urea-formaldehyde resins, melamine resins, polystyrenes, styrene-methacrylate copolymers and styrene-acrylate copolymers. Among these polymer substances, polyurethanes, polyureas, polyamides, polyesters and polycarbonates are preferable and polyurethanes and polyureas are more preferable.

For example, when a polyurea is used as the wall material of the microcapsule, the wall of the microcapsule can be easily formed by allowing to react a polyisocyanate such as a diisocyanate, a triisocyanate, a tetraisocyanate and a polyisocyanate prepolymer with a polyamine such as a diamine, a triamine and a tetramine, a prepolymer having two or more amino groups, piperadine, a derivative of piperadine, a polyol or the like in the aqueous phase by the interfacial polymerization method.

A composite wall composed of a polyurea and a polyamide or a composite wall composed of a polyurethane and a polyamide can be prepared by mixing a polyisocyanate, for example, with a second substance which forms the capsule wall by reaction with the polyisocyanate such as an acid chloride, a polyamine and a polyol in an aqueous solution of a water-soluble polymer (the aqueous phase) or in an oil medium (the oil phase) which forms the capsule, dispersing the mixed components to prepare an emulsion and heating the prepared emulsion. This method for preparing a composite wall composed of a polyurea and a polyamide is described in detail in JP-A 58-66948.

As the polyisocyanate compound, compounds having 3 or more functional isocyanate groups are preferable. Bifunctional isocyanate compounds having two functional isocyanate groups may be used in combination.

Specific examples of the polyisocyanate compound include dimers and trimers of diisocyanates (biurets and isocyanurates) which are prepared by using the diisocyanates such as xylylene diisocyanate, hydrogenated xylylene diisocyanate, hexamethylene diisocyanate, tolylene diisocyanate, hydrogenated tolylene diisocyanate and isophorone diisocyanate as the main material; multi-functional adducts of polyols such as trimethylolpropane with bifunctional isocyanates such as xylylene diisocyanate; compounds prepared by introducing macromolecular compounds such as polyethers having active hydrogen atoms, such as polyethylene oxide, into adducts of polyols such as trimethylolpropane with bifunctional diisocyanates such as xylylene diisocyanate; and condensation products of benzene isocyanate with formalin.

The compounds described in JP-A 62-212190, JP-A 4-26189, JP-A 5-317694 and Japanese Patent Application No. 8-268721 are preferable as the polyisocyanate compound.

It is preferable that the polyisocyanate is added so as to provide microcapsules having an average particle diameter in the range of 0.3 to 12 μm and a thickness of the wall in the range of 0.01 to 0.3 μm. The diameter of the dispersed particles is generally in the range of 0.2 to 10 μm.

Specific examples of the polyol and/or the polyamine which is added to the aqueous phase and/or the oil phase as a component which forms the wall of the microcapsule by reaction with the polyisocyanate include propylene glycol, glycerol, trimethylolpropane, triethanolamine, sorbitol and hexamethylenediamine. A polyurethane microcapsule wall is formed when the polyol is added. To increase the reaction rate in the above reaction, it is preferable that the reaction temperature is kept high or that a suitable polymerization catalyst is added.

The polyisocyanate, the polyol, the reaction catalyst and the polyamine used for forming a portion of the wall are described in detail in “Polyurethane Handbook” edited by Keiji Iwata and published by Nikkan Kogyo Shinbun Co., Ltd. (1987).

Metal-containing dyes, electric charge controlling agents such as nigrosin and other optional additives can be contained in the microcapsule wall, if necessary. These additives can be added to the wall during formation of the capsule wall or at any other desired step. A monomer such as a vinyl monomer may be graft polymerized to the capsule wall to control the electric charge at the surface of the wall, if necessary.

It is preferable that a plasticizer suitable for the polymer used as the wall material is used to obtain a microcapsule wall exhibiting excellent permeation of substances at lower temperatures and having an excellent color developing property. The plasticizer preferably has a melting point of 50° C. or higher and more preferably a melting point of 120° C. or lower. Among such plasticizers, a solid plasticizer at an ordinary temperature can be suitably selected and used.

For example, when the wall material is a polyurea or a polyurethane, hydroxy compounds, esters of carbamic acid, aromatic alkoxy compounds, organic sulfonamides, aliphatic amides and arylamides are preferably used.

In the preparation of the oil phase, an organic solvent having a boiling point of 100 to 300° C. is preferably used as the hydrophobic organic solvent used for dissolving the electron-donating dye precursor or the photodecomposable diazo compound and for forming the core of the microcapsule.

Specific examples of the organic solvent include esters, dimethylnaphthalene, diethylnaphthalene, diisopropylnaphthalene, dimethylbiphenyl, diisopropylbiphenyl, diisobutylbiphenyl, 1-methyl-1-dimethylphenyl-2-phenylmethane, 1-ethyl-1-dimethylphenyl-1-phenylmethane, 1-propyl-1-dimethylphenyl-1-phyenylmethane, triarylmethanes such as tritoluylmethane and toluyldiphenylmethane, terphenyl compounds such as terphenyl, alkyl compounds, alkylated diphenyl ethers such as propyl diphenyl ether, hydrogenated terphenyl such as hexahydroterphenyl and diphenyl ethers. Among these solvents, esters are preferably used from the standpoint of stability of the dispersed emulsion.

Examples of the esters include esters of phosphoric acid such as triphenyl phosphate, tricresyl phosphate, butyl phosphate, octyl phosphate and cresyl phenyl phosphate; esters of phthalic acid such as dibutyl phthalate, 2-ethylhexyl phthalate, ethyl phthalate, octyl phathalate and butyl benzyl phthalate; dioctyl tetrahydrophthalate; esters of benzoic acid such as ethyl benzoate, propyl benzoate, butyl benzoate, isopentyl benzoate and benzyl benzoate; esters of abietic acid such as ethyl abietate and benzyl abietate; dioctyl adipate; isodecyl succinate; dioctyl azelate; esters of oxalic acid such as dibutyl oxalate and dipentyl oxalate; diethyl malonate; esters of maleic acid such as dimethyl maleate, diethyl maleate and dibutyl maleate; tributyl citrate; esters of sorbic acid such as methyl sorbate, ethyl sorbate and butyl sorbate; esters of sebacic acid such as dibutyl sebacate and dioctyl sebacate; esters of ethylene glycol such as monoesters and diesters of formic acid, monoesters and diesters of butyric acid, monoesters and diesters of lauric acid, monoesters and diesters of palmitic acid, monoesters and diesters of stearic acid and monoesters and diesters of oleic acid; triacetin; diethyl carbonate; diphenyl carbonate; ethylene carbonate; propylene carbonate; and esters of boric acid such as tributyl borate and tripentyl borate.

Among these esters, tricresyl phosphate is preferable because the emulsion obtained is the most stable when used both singly or in a mixture. The above oils can also be used in combination or in a combination with other oils.

When the solubility of the electron-donating dye precursor or the photodecomposable diazo compound used for the microcapsule in the hydrophobic organic solvent is poor, a solvent having a lower boiling point and exhibiting a better solubility can be used in combination as an auxiliary. Preferable examples of the auxiliary solvent having a lower boiling point include ethyl acetate, isopropyl acetate, butyl acetate and methylene chloride and the like.

When the above electron-donating dye precursor or the photodecomposable diazo compound is used in the heat-sensitive recording layer in the heat-sensitive recording material, the amount of the electron-donating dye precursor is preferably in the range of 0.1 to 5.0 g/m² and more preferably in the range of 1.0 to 3.5 g/m².

The amount of the photodecomposable diazo compound is preferably in the range of 0.02 to 5.0 g/m² and more preferably in the range of 0.10 to 4.0 g/m² from the standpoint of the density of the developed color.

When the amount of the electron-donating dye precursor is less than 0.1 g/m² or the amount of the photodecomposable diazo compound is less than 0.02 g/m², a sufficient density of the developed color is not occasionally obtained. When the amount of the electron-donating dye precursor and that of the photodecomposable diazo compound exceed 5.0 g/m², transparency of the heat-sensitive recording layer occasionally deteriorates.

As the aqueous phase, an aqueous solution prepared by dissolving a water-soluble polymer contained as the protective colloid is used. The above oil phase material is added to the aqueous solution and dispersed to prepare an emulsion by using devices such as a homogenizer. The water-soluble polymer works as a dispersing medium so that a uniformly dispersed emulsion can be obtained easily and the obtained emulsion is stable. A surfactant may be added to at least one of the oil phase and the aqueous phase to make the emulsion more uniformly dispersed and more stable. A conventional surfactant for emulsification can be used as the surfactant. The added amount of the surfactant is preferably 0.1 to 5% and more preferably 0.5 to 2% of the weight of the oil phase.

As the surfactant added to the aqueous phase, surfactants which do not form precipitates or agglomerates by interaction with the protective colloid can be suitably selected from anionic and nonionic surfactants.

Preferable examples of the surfactant include sodium alkylbenzene-sulfonates, sodium alkylsulfates, sodium salt of dioctyl sulfosuccinate and polyalkylene glycols such as polyoxyethylene nonylphenyl ether.

The emulsion can be easily prepared from the oil phase containing the above components and the aqueous phase containing the protective colloid and the surfactant by a means generally used for microemulsification such as high speed stirring and dispersion by ultrasonic waves using a conventional emulsifying apparatus such as a homogenizer, a Manton Gaulin, an ultrasonic disperser, a dissolver or a KD mill. After emulsification, the formed emulsion is preferably heated to 30 to 70° C. to accelerate the reaction for forming the wall of the capsule. To prevent agglomeration of the capsules during the reaction, it is preferable that water is added to decrease the probability of collision between the capsules and that sufficient stirring is conducted.

An additional amount of the dispersion may be added during the reaction to prevent agglomeration. Generation of carbon dioxide is observed as the polymerization reaction proceeds, and the formation of the wall of the capsule can be considered to be completed around the time when the formation of carbon dioxide ends. The object microcapsules can be obtained generally after the reaction has continued for several hours.

When capsules are prepared using the electron-donating dye precursor or the photodecomposable diazo compound as the core material, the electron-accepting compound or the coupler may be used in a solid form in combination with the water-soluble polymer, the organic base and other components such as color forming auxiliary agents, by dispersing by a means such as a sand mill. However, it is preferable that, after these components are dissolved into an organic solvent having a high boiling point which is insoluble or slightly soluble in water in advance, the resultant solution is mixed with an aqueous solution of the polymer (the aqueous phase) which contains the surfactant and/or the water-soluble polymer as the protective colloid and the resultant mixture is emulsified by a homogenizer or the like to prepare a dispersed emulsion. A solvent having a low boiling point can be used as an auxiliary agent for dissolution.

The coupler and the organic base may be elsified and dispersed separately or may be mixed together, dissolved into a solvent having a high boiling point and then emulsified and dispersed. The diameter of the particles in the emulsion is preferably lpm or less.

The organic solvent with a high boiling point used above can be suitably selected, for example, from oils having a high boiling point which are described in JP-A 2-141279.

It is preferable from the standpoint of stability of the dispersed emulsion that esters are used from among these solvents. Tricresyl phosphate is particularly preferable. A combination of the oils described above or a combination of the oils described above with other oils may also be use.

The water-soluble polymer contained as the protective colloid can be suitably selected from conventional anionic polymers, nonionic polymers and amphoteric polymers. A water-soluble polymer having solubility in water of 5% or more at the temperature of emulsification is preferable. Specific examples of such polymers include polyvinyl alcohol, modified polyvinyl alcohols, polyacrylic amide, derivatives of polyacrylic amide, ethylene-vinyl acetate copolymers, styrene-maleic anhydride copolymers, ethylene-maleic anhydride copolymers, isobutylene-maleic anhydride copolymers, polyvinylpyrolidone, ethylene-acrylic acid copolymers, vinyl acetate-acrylic acid copolymers, derivatives of cellulose such as carboxymethylcellulose and methylcellulose, casein, gelatin, derivatives of starch, gum arabic and sodium alginate.

Among these polymers, polyvinyl alcohol, gelatin and derivatives of cellulose are particularly preferable.

The oil phase is mixed with the aqueous phase preferably in a ratio (the weight of the oil phase/the weight of the aqueous phase) of 0.02 to 0.6 and more preferably in a ratio of 0.1 to 0.4. When the ratio is less than 0.02, the emulsion is excessively dilute due to the excessive amount of the aqueous phase and the emulsion is not suitable for production. When the ratio exceeds 0.6, the emulsion has excessively high viscosity so as to cause inconvenience in handling and a decrease in the stability of the coating solution. Therefore, such ratios are not preferable.

When the electron-accepting compound is used in the heat-sensitive recording material, the electron-accepting compound is preferably used in an amount of 0.5 to 30 parts by weight and more preferably 1.0 to 10 parts by weight per 1 part by weight of the electron-donating dye precursor.

When the coupler is used in the heat-sensitive recording material, the coupler is preferably used in an amount of 0.1 to 30 parts by weight per 1 part by weight of the diazo compound.

The coating solution for the heat-sensitive recording layer can be prepared, for example, by mixing the microcapsule solution and the dispersed emulsion prepared as described above. The water-soluble polymer used as the protective colloid during preparation of the microcapsule solution and the water-soluble polymer used as the protective colloid during preparation of the dispersed emulsion function as a binder in the heat-sensitive recording layer. A binder other than these protective colloids may also be added, mixed, and used to prepare the coating solution for the heat-sensitive recording layer.

A binder soluble in water is generally used as the binder to be added. Examples of the binder include polyvinyl alcohol, hydroxyethylcellulose, hydroxypropylcellulose, epichlorohydrin modified polyamides, ethylene-maleic anhydride copolymers, styrene-maleic anhydride copolymers, isobutylene-maleic anhydride-salicylic acid copolymers, polyacrylic acid, polyacrylamide, methylol modified polyacrylamide, derivatives of starch, casein and gelatin.

To provide the binder with resistance to water, an agent for providing resistance to water or an emulsion of a hydrophobic polymer, such as a styrene-butadiene rubber latex or an acrylic resin emulsion may be added.

To apply the coating solution for the heat-sensitive recording layer onto a substrate, a conventional method for coating a water-based coating solution or an organic solvent-based coating solution is used. In the heat-sensitive recording material, methylcellulose, carboxymethylcellulose, hydroxyethylcellulose, starches, gelatin, polyvinyl alcohol, carboxy modified polyvinyl alcohol, polyacrylamide, polystyrene, copolymers of styrene, polyesters, copolymers containing polyesters, polyethylene, copolymers of ethylene, epoxy resins, acrylate resins, copolymer resins of acrylates, methacrylate resins, copolymer resins of methacrylates, polyurethane resins, polyamide resins or polyvinyl butyral resins may be used to achieve safe and uniform application of the coating solution for the heat-sensitive recording layer onto the substrate and to maintain the strength of the resultant coated layer.

Other components which can be used in the heat-sensitive recording layer will be described hereinafter.

The other components are not particularly limited and can be suitably selected in accordance with the object. For example, conventional heat melting substances, ultraviolet light absorbents and antioxidants can be used.

The heat melting substance may be contained in the heat-sensitive recording layer to improve the response to heat.

Examples of the heat melting substance include aromatic ethers, thioethers, esters, aliphatic amides and ureides.

These compounds are described in JP-A 58-57989, JP-A 58-87094, JP-A 61-58789, JP-A 62-109681, JP-A 62-132674, JP-A 63-151478, JP-A 63-235961, JP-A 2-184489 and JP-A 2-215585.

As the above ultraviolet light absorbent, benzophenone ultraviolet light absorbents, benzotriazole ultraviolet light absorbents, salicylic acid ultraviolet light absorbents, cyanoacrylate ultraviolet light absorbents and oxalic acid anilide ultraviolet light absorbents can be advantageously used. Examples of the above ultraviolet light absorbents are described in JP-A 47-10537, JP-A 58-111942, JP-A 58-212844, JP-A 59-19945, JP-A 59-46646, JP-A 59-109055, JP-A 63-53544, Japanese Patent Publication (hereinafter abbreviated as JP-B) No. 36-10466, JP-B-42-26187, JP-B-48-30492, JP-B-48-31255, JP-B-48-41572, JP-B-48-54965, JP-B-50-10726 and U.S. Pat. Nos. 2,719,086, 3,707,375, 3,754,919 and 4,220,711.

As the above antioxidant, hindered amine antioxidants, hindered phenol antioxidants, aniline antioxidants and quinoline antioxidants can be advantageously used. Examples of the antioxidants are described in JP-A 59-155090, JP-A 60-107383, JP-A 60-107384, JP-A 61-137770, JP-A 61-139481 and JP-A 61-160287.

The above-described other components are preferably used in an amount of 0.05 to 1.0 g/m² and more preferably of 0.1 to 0.4 g/m². The other components may be contained in the inside or the outside of the microcapsule.

It is preferable that the heat-sensitive recording layer has a large dynamic range, i.e., a large energy range required to obtain the saturated transmission density D_{T}-max, to obtain high quality images by suppressing fluctuations in the density caused by slight differences in the thermal conductivity between heating elements in the thermal head. It is preferable that the heat-sensitive recording material includes such a heat-sensitive recording layer and that the heat-sensitive recording layer can exhibit a transmission density D_{T} of 3.0 with a thermal energy in a range of 90 to 150 mJ/mm².

It is preferable that the heat-sensitive recording layer is formed so that the layer obtained after the coating solution is applied and dried has a weight of 1 to 25 g/m² and has a thickness of 1 to 25 μm.

In the heat-sensitive recording material, a transparent substrate is preferably used to obtain a transparent heat-sensitive recording material. Examples of the transparent substrate include synthetic polymer films such as polyester films such as a polyethylene terephthalate film and a polybutylene terephthalate film; a cellulose triacetate films; and polyolefin films such as a polypropylene film and a polyethylene film. The above films can be used as a single film or as a laminate of a plurality of films.

The thickness of the film of the synthetic polymer is preferably in the range of 25 to 250 μm and more preferably in the range of 50 to 200 μm.

The above synthetic polymer films may be colored to a desired hue. As the method for coloring synthetic polymer films, a method in which a dye is mixed with a resin before preparation of a resin film and then a film is formed by using the colored resin, or a method in which a coating solution is prepared by dissolving a dye into a suitable solvent and the prepared coating solution is applied to a transparent colorless resin film by a conventional method such as gravure coating, roller coating or wire coating, can be used. A polyester resin film (such as a polyethylene terephthalate film or a polyethylene naphthalate film) which is prepared by mixing a polyester resin with a blue dye and forming the mixture into a film, and which is then treated by a treatment for improving heat resistance, a stretching treatment and an antistatic treatment, is preferably used.

When the transparent heat-sensitive recording material is observed on an illuminating table with the substrate side facing the observer, it is occasionally difficult to discern the images due to haze formed by the light of the illuminating table passing through transparent portions having no images.

To prevent the above phenomenon, it is preferable that a synthetic polymer film which has a blue color in the quadrangular region formed by four points which are a point A (x=0.2805, y=0.3005), a point B (x=0.2820, y=0.2970), a point C (x=0.2885, y=0.3015) and a point D (x=0.2870, y=0.3040) on the chromaticity coordinate system in accordance with the method described in Japanese Industrial Standard Z8701, is used as the transparent substrate.

The heat-sensitive recording material can be formed such that an intermediate layer, a primer layer, an ultraviolet light absorbing filter layer, a light reflection preventing layer or the like is provided as the other layer on the substrate.

It is preferable that an intermediate layer is provided on the heat-sensitive recording layer.

The intermediate layer is provided to prevent layer mixing and to cut off gas (e.g., oxygen) which is harmful to image preservability. The binder to be used is not particularly limited and polyvinyl alcohol, gelatin, polyvinyl pyrolidone, derivatives of cellulose and the like can be used depending on the system. Various types of surfactants may also be added in order to facilitate coating. Inorganic fine particles such as mica may be added in an amount of 2 to 20% by weight and more preferably of 5 to 10% by weight of the binder in order to increase gas barrier ability.

In the heat-sensitive recording material of the present invention, it is preferable that the substrate is coated with a primer layer to prevent separation of the heat-sensitive recording layer from the substrate before the substrate is coated with the heat-sensitive recording layer containing the microcapsules and the like and the light reflection preventing layer.

For the primer layer, acrylic ester copolymers, polyvinylidene chloride, SBR and hydrophilic polyesters can be used. The thickness of the layer is preferably 0.05 to 0.5 μm.

When the heat-sensitive recording layer is coated on the primer layer, images recorded on the heat-sensitive recording layer are occasionally deteriorated by the swelling of the primer layer caused by water contained in the coating solution for the heat-sensitive recording layer. Therefore, it is preferable that a hardening agent such as a dialdehyde such as glutaraldehyde or 2,3-dihydroxy-1,4-dioxane or boric acid is used in the primer layer to harden the layer. The hardening agent can be used in an amount suitable for providing a desired hardness, i.e., in an amount in the range of 0.2 to 3.0% by weight of the weight of the material of the primer layer.

On a back surface of the substrate, i.e., the surface at the side opposite to the coating surface of the heat-sensitive recording layer, an ultraviolet light absorbing filter layer may be provided to prevent color fading of the printed image. In the ultraviolet light absorbing filter layer, an ultraviolet light absorbent such as a benzotriazole ultraviolet light absorbent, a benzophenone ultraviolet light absorbent, or a hindered amine ultraviolet light absorbent is contained.

A light reflection preventing layer which contains fine particles having an average particle diameter of 1 to 20 μm and preferably of 1 to 10 μm may be formed on the back surface of the substrate at the side opposite the side at which the heat-sensitive recording layer is coated.

The gloss measured at an incident light angle of 20° C. is preferably adjusted to 50% or less and more preferably to 30% or less by forming the light reflection preventing layer.

As the fine particles contained in the light reflection preventing layer, fine particles of starch obtained from barley, wheat, corn, rice or beans; fine particles of synthetic polymers such as cellulose fibers, polystyrene resins, epoxy resins, polyurethane resins, urea-formaldehyde resins, poly (meth)acrylate resins, polymethyl (meth)acrylate resins, copolymer resins of vinyl chloride or vinyl actate and polyolefins; and fine particles of inorganic substances such as calcium carbonate, titanium oxide, kaolin, smectite clay, aluminum hydroxide, silica and zinc oxide, can be used.

A single type or a combination of two or more types of the fine particulate substances can be used. It is preferable that the fine particulate substance has a refractivity index of 1.45 to 1.75 to achieve excellent transparency of the heat-sensitive recording material.

Although the heat-sensitive recording material can be produced favorably by a method of producing the heat-sensitive recording material according to the present invention described below, the present invention is not limited thereto and other methods can be used as well.

Since the coating solution for the protective layer contains the emulsion of silicone oil, which is dispersed such that the average particle diameter is 0.15 μm or less, the heat-sensitive recording material has excellent head matching performance and an excellent coated surface without any coating defects. Thus, in particular, the heat-sensitive recording material is advantageously used as a recording material in the medical field in which stable formation of high quality images is required.

The method for producing the heat-sensitive recording material is described hereinafter.

The method for producing the heat-sensitive recording material includes steps of forming a heat-sensitive recording layer on a substrate by coating a coating solution for forming the heat-sensitive recording layer, forming a protective layer by coating a coating solution for forming the protective layer containing at least a pigment and a binder, and forming other layers if necessary.

The heat-sensitive recording layer and the protective layer may be formed simultaneously. In this case, the coating solution for forming the heat-sensitive recording layer and the coating solution for forming the protective layer are coated on the substrate in the same process, so that the heat-sensitive recording layer and the protective layer thereon can be formed in the same process.

According to the method for producing the heat-sensitive recording material, an emulsion of silicone oil, which is dispersed such that the average particle diameter is 0.15 μm or less, is contained in the coating solution for forming the protective layer. Accordingly, the emulsion is safe from being damaged by a shear when passing through a pump or a filter when the liquid is being fed, or by an ultrasonic deaerator. As a result, huge oil droplets, which might cause coating defects due to repelling, are not formed. Thus, this method of production is extremely stable.

As the substrate, the above-described substrate which is used for the heat-sensitive recording material may be used. As the coating solution for forming the heat-sensitive recording layer, the above-described coating solution for the heat-sensitive recording layer can be used. Similarly, as the coating solution for forming the protective layer, the above-described coating solution for the protective layer containing the pigment and the binder can be used.

Examples of the other layers include other layers such as the above-described intermediate layer and primer layer.

According to the method for producing the heat-sensitive recording material, a conventional coating method such as blade coating, air knife coating, gravure coating, roll coating, spray coating, dip coating or bar coating is used to form the primer layer, the heat-sensitive recording layer, the intermediate layer, the protective layer and the like one after another on the substrate. By using the method, the heat-sensitive recording material of the present invention can be produced.

The present invention will be specifically explained with reference to the following examples. The materials, regents, ratios, procedures and so forth shown in the following examples can be optionally changed so long as such change does not depart from the spirit of the present invention. Therefore, the scope of the present invention is not limited by the following examples.

### EXAMPLE 1

(Preparation of Silver Halide Emulsion 1)

To 1,421 ml of water, added were 8 ml of 1 wt % potassium bromide solution, 8.2 ml of 1 mol/L nitric acid and 20 g of phthalized gelatin, the mixture was kept stirred in a titanium-coated stainless reaction vessel at a constant liquid temperature of 37° C., and was then added with an entire volume of solution “A” obtained by dissolving 37.04 g of silver nitrate in distilled water and diluting it up to 159 ml, by the controlled double jet method at a constant flow rate over 1 minute while keeping pAg at 8.1. Solution “B” obtained by dissolving 32.6 g of potassium bromide in water and diluting it up to 200 ml was also added by the controlled double jet method. After that, 30 ml of 3.5 wt % aqueous hydrogen peroxide solution was added, and 36 ml of 3 wt % aqueous solution of Compound (1) was further added. Solution “A” was further diluted with distilled water to 317.5 ml to obtain solution “A2”, and solution “B” was further added with Compound 2 so as to attain a final concentration thereof of 1×10⁻⁴ mol/mol Ag and diluted with distilled water up to doubled volume of 400 ml to obtain solution “B2”. Again an entire volume of solution “A2” was added to the mixture by the controlled double jet method at a constant flow rate over 10 minute while keeping pAg at 8.1. Solution “B2” was also added by the controlled double jet method. After that, the mixture was added with 50 ml of 0.5 wt % methanol solution of Compound 3, the pAg of which was raised to 7.5 with silver nitrate, the pH of which was then adjusted to 3.8 with an 1 mol/L sulfuric acid, stopped stirring, subjected to precipitation/desalting/washing processes, added with 3.5 g of deionized gelatin, the pH and pAg of which were adjusted to 6.0 and 8.2, respectively, with an 1 mol/L sodium hydroxide, thereby to obtain a silver halide emulsion.

Grain in the resultant silver halide emulsion was found to be a pure silver bromide grain with an average sphere-equivalent diameter of 0.053 μm and a sphere-equivalent coefficient of variation of 18%. Grain size and so forth were determined based on an average diameter of 1,000 grains under electron microscopic observation. Ratio of [100] plane of such grain was determined as 85% based on the method of Kubelka-Munk.

The above emulsion was heated to 50° C. under stirring and 5 ml of 0.5 wt % solution of Compound 4 and 5 ml of 3.5 wt % solution of Compound 5 were added. In one minute after the completion of the addition, Compound 6 was added in an amount of 3×10⁻⁵ mol/mol Ag. Two minutes later, a solid dispersion of Sensitizing Dye A (aqueous gelatin solution) was added thereto in an amount of 5×10⁻³ mol/mol Ag. Still two minutes later, Tellurium Sensitizer B was added thereto in an amount of 5×10⁻⁵ mol/mol Ag, and was then ripened for 50 minutes. Just before completion of the ripening, Compound 3 and Compound A were added in an amount of 7×10⁻³ mol/mol Ag and 6.4×10⁻³ mol/mol Ag, respectively. Temperature of the mixture was reduced whereby the chemical sensitization was completed to obtain Silver Halide Emulsion 1.

(Preparation of Silver Halide Emulsion 2)

An emulsion containing pure silver bromide grain emulsion with an average sphere-equivalent diameter of 0.08 μm and a variation in sphere-equivalent coefficient of 15% was prepared by the method for preparation of Silver Halide Emulsion 1 except that the temperature of the mixed solution during the preparation of grains was raised to 50° C. instead of 37° C. Precipitation/desalting/washing/dispersion were performed similarly to the method for preparation of Silver Halide Emulsion 1. Except that the amount of addition of Spectral Sensitizing dye A is changed to 4.5×10⁻³ mol/mol Ag, the spectral sensitization, chemical sensitization, addition of Compound 3 and Compound A were also performed similarly to those in the case of Silver Halide Emulsion 1, thereby to obtain Silver Halide Emulsion 2.

(Preparation of Mixed Emulsion “A” for Coating)

A coating solution was prepared by mixing 80 wt % of Silver Halide Emulsion 1 and 20 wt % of Silver Halide Emulsion 2 to obtain a solution and adding 1 wt % solution of Compound B in an amount of 7×10⁻³ mol/mol Ag.

(Preparation of Silver Behenate Dispersion)

In an amount of 87.6 kg of behenic acid (Edenor C22-85R, produced by Henkel Co.), 423 L of distilled water, 49.2 L of 5 mol/L aqueous solution of NaOH and 120 L of tert-butanol were mixed and allowed to react with stirring at 75° C. for one hour to obtain a solution of sodium behenate. Separately, 206.2 L of an aqueous solution containing 40.4 kg of silver nitrate was prepared and kept at 10° C. A mixture of 635 L of distilled water and 30 L of tert-butanol contained in a reaction vessel kept at 30° C. was added with the whole amount of the aforementioned sodium behenate solution and the whole amount of the aqueous silver nitrate solution with stirring at constant flow rates over the periods of 62 minutes and 10 seconds, and 60 minutes, respectively. In this operation, the aqueous silver nitrate solution was added in such a manner that only the aqueous silver nitrate solution should be added for 7 minutes and 20 seconds after starting the addition of the aqueous silver nitrate solution, and then the addition of the aqueous solution of sodium behenate was started and added in such a manner that only the aqueous solution of sodium behenate should be added for 9 minutes and 30 seconds after finishing the addition of the aqueous silver nitrate solution. During the addition, the temperature was controlled so that the temperature in the reaction vessel should be 30° C. and the liquid temperature should not be raised. The piping of the addition system for the sodium behenate solution was warmed by steam trace and the steam amount was controlled so that the liquid temperature at the outlet orifice of the addition nozzle should be 75° C. Further, the piping of the addition system for the aqueous silver nitrate solution was maintained by circulating cold water outside a double pipe. The addition position of the sodium behenate solution and the addition position of the aqueous silver nitrate solution were arranged symmetrically with respect to the stirring axis as the center, and the positions were controlled to be at heights for not contacting with the reaction mixture.

After finishing the addition of the sodium behenate solution, the mixture was left with stirring for 20 minutes at the same temperature and then the temperature was decreased to 25° C. Thereafter, the solid content was recovered by suction filtration and the solid content was washed with water until electric conductivity of the filtrate became 30 μS/cm. The solid content obtained as described above was stored as a wet cake without being dried.

When the shape of the obtained silver behenate grains was evaluated by electron microscopic photography, the grains were scaly crystals having a mean diameter of projected areas of 0.52 μm, mean thickness of 0.14 μm and variation coefficient of 15% for mean diameter as spheres.

To the wet cake corresponding to 100 g of the dry solid content were added 7.4 g of polyvinyl alcohol (PVA-205, produced by Kuraray Co. Ltd.) and water to make the total amount 385 g, and the mixture was pre-dispersed by a homomixer. Then, the pre-dispersed stock dispersion was treated three times by using a dispersing machine (Microfluidizer-M-110S-EH, produced by Microfluidex International Corporation, using G10Z interaction chamber) with a pressure controlled to be 1750 kg/cm² to obtain Silver behenate dispersion. During the cooling operation, a desired dispersion temperature was achieved by providing coiled heat exchangers fixed before and after the interaction chamber and controlling the temperature of the refrigerant.

(Preparation of 25 Weight Percent Dispersion of Reducing Agent)

A slurry was prepared by adding 176 g of water to 64 g of a 20 weight percent aqueous solution of modified polyvinyl alcohol Poval MP-203 made by Kuraray Co., Ltd. and 80 g of 1,1-bis(2-hydroxy-3,5-dimethylphenyl)-3,5,5-trimethylhexane and stirring the mixture thoroughly. 800 g of zirconia beads with an average diameter of 0.5 mm was prepared and charged together with the slurry to a vessel. The mixture was dispersed for 5 hr in a disperser (¼ G sand grinder mill, made by Imex (Ltd.)), yielding a reducing agent dispersion. The reducing agent particles contained in the reducing agent dispersion thus obtained were 0.72 micrometer in average diameter.

(Preparation of 20 Weight Percent Dispersion of Mercapto Compound)

A slurry was prepared by adding 224 g of water to 32 g of a 20 weight percent aqueous solution of modified polyvinyl alcohol (Poval MP-203 made by Kuraray Co., Ltd.) and 64 g of above-described compound A, and stirring the mixture thoroughly. 800 g of zirconia beads with an average diameter of 0.5 mm was prepared and charged together with the slurry to a vessel. The mixture was dispersed for 10 hr in a disperser (¼ G sand grinder mill, made by Imex (Ltd.)), yielding a mercapto dispersion. The average particle diameter of the mercapto compound particles contained in the mercapto compound dispersion thus obtained was 0.67 micrometer.

(Preparation of 30 Weight Percent Dispersion of Organic Polyhalogen Compound)

A slurry was prepared by adding 224 g of water to 48 g of a 20 weight percent aqueous solution of modified polyvinyl alcohol (Poval MP-203, made by Kuraray Co., Ltd.), 48 g of 3-tribromomethylsulfonyl-4-phenyl-5-tridecyl-1,2,4-trazole, and 48 g of tribromomethylphenylsulfon, and stirring the mixture thoroughly. 800 g of zirconia beads with an average diameter of 0.5 mm was prepared and charged together with the slurry to a vessel. The mixture was dispersed for 5 hr in a disperser (¼ G sand grinder mill, made by Imex (Ltd.)), yielding an organic polyhalogen compound. The average particle diameter of the polyhalogen compound particles contained in the polyhalogen compound dispersion thus obtained was 0.74 micrometer.

(Preparation of 10 Weight Percent Methanol Solution of Phthalazine Compound)

10 g of 6-isopropylph.thalazine was dissolved in 90 g of methanol for use.

(Preparation of 20 Weight Percent Dispersion of Pigment)

A slurry was prepared by adding 250 g of water to 6.4 g of Demol N made by Kao Corporation and 64 g of C. I. Pigment Blue 60 and stirring the mixture thoroughly. 800 g of zirconia beads with an average diameter of 0.5 mm was prepared and charged together with the slurry to a vessel. The mixture was dispersed for 25 hr in a disperser (¼ G sand grinder mill, made by Imex (Ltd.)), yielding a pigment dispersion. The average particle diameter of the pigment particles contained in the pigment dispersion thus obtained was 0.21 micrometer.

(Preparation of 40 Weight Percent SBR Latex)

SBR latex refined by ultrafiltration (UF) was obtained as follows. The SBR latex indicated below was diluted 10-fold with distilled water and dilution purified to an ionic conductivity of 1.5 mS/cm using a UF-purification module, the FS03-FC-FUY03A1 (made by Daisen Membrane Systems (Ltd.)). The latex concentration at that time was 40 weight percent.

(SBR Latex: -St(68)-Bu(29)-AA(3)-Latex)

Equilibrium water content 0.6 weight percent (25° C., 60 percent relative humidity), average particle diameter 0.1 micrometer, concentration 45 weight percent, ionic conductivity 4.2 mS/cm (in ionic conductivity measurement, a conductivity meter CM-30S made by Toa Denpa Kogyo (K.K.) was used to measure the latex starting solution (40 weight percent) at 25° C.), pH 8.2.

(Preparation of Emulsion Layer (Photosensitive Layer) Coating Solution)

1.1 g of the 20 weight percent dispersion of pigment obtained as set forth above, 103 g of the organic acid silver dispersion, 5 g of the 20 weight percent aqueous solution of polyvinyl alcohol PVA-205 (made by Kuraray Co., Ltd.), 25 g of the above-described 25 weight percent dispersion of the reducing agent, 11.5 g of the 30 weight percent dispersion of the organic polyhalogen compound, 3.1 g of the 20 weight percent dispersion of the mercapto compound, 106 g of the 40 weight percent the UF-refined SBR latex, and 16 mL of the 10 weight percent solution of the phthalazine compound were admixed. 10 g of silver halide mixed emulsion A was thoroughly admixed to prepare an emulsion layer coating solution, and this solution was applied to 70 mL/m². The viscosity of the emulsion layer coating solution was measured with a type B viscometer in the form of a Tokyo measuring apparatus at 85 (mPa·s) at 40° C. (No. 1 rotor). The viscosity of the coating solution at 25° C. as measured with an RFS fluid spectrometer made by Rheometrix Far East K.K. at shear rates of 0.1, 1, 10, 100, and 1,000 (1/sec.) was 1,500, 220, 70, 40, and 20 (mPa·s).

(Preparation of Intermediate Layer Coating Solution for Emulsion Layer Side)

2 mL of a 5 weight percent aqueous solution of Aerosol OT (made by American Cyanide Co.) was added to 772 g of a 10 weight percent aqueous solution of polyvinyl alcohol (PVA-205 made by Kuraray Co., Ltd.), 0.5 g of a 20 weight percent dispersion of pigment, and 226 g of a 27.5 weight percent solution of latex in the form of a methyl methacrylate/styrene/2-ethylhexyl acrylate/hydroxyethyl methacrylate/acrylic acid copolymer (copolymerization weight ratio: 59/9/26/5/1) to obtain an intermediate layer coating solution. This coating solution was applied to 5 mL/m². The viscosity of the coating solution as measured by type B viscometer at 40° C. (No. 1 rotor) was 21 (mPa·s).

(Preparation of Coating Solution of First Protective Layer for Emulsion Layer Side)

72 g of inert gelatin was dissolved in water. To this solution were added 8 g of latex (methyl methacrylate/acrylic acid/N-methylol acrylamide copolymer (copolymerization weight ratio 93/3/4)), 0.3 g of a 20 weight percent dispersion of pigment, 64 mL of a 10 weight percent methanol solution of phthalic acid, 74 mL of a 10 weight percent aqueous solution of 4-methylphthalic acid, 28 mL of 0.5 mol/L sulfuric acid, and 5 mL of a 5 weight percent aqueous solution of Aerosol OT (made by American Cyanide Co.). Water was added to make 1,000 g, yielding the coating solution of the first protective layer for emulsion layer side. This coating solution was applied to 20 mL/m². The viscosity of the coating solution as measured by type B viscometer at 40° C. (No. 1 rotor) was 17 (mPa·s).

(Preparation of Coating Solution of Second Protective Layer for Emulsion Layer Side)

90 g of inert gelatin was dissolved in water. To this solution were added 10 g of latex A, 20 mL of a 5 weight percent solution of N-perfluorooctylsulfonyl-N-propylalanine potassium salt, 16 mL of a 5 weight percent solution of Aerosol OT (made by American Cyanide Co.), 4 g of polymethyl methacrylate microparticles (average particle diameter 0.7 micrometer), 21 g of polymethyl methacrylate microparticles (average particle diameter 6.4 micrometers), 1.4 g of phthalic acid, 1.6 g of 4-methylphthalic acid, 44 mL of 0.5 mol/L of sulfuric acid, and 445 mL of 4 weight percent chrome alum. Water was added to make 2,000 g, yielding the coating solution of the second protective layer for emulsion layer side. This coating solution was applied to 20 mL/m². The viscosity of the coating solution as measured by type B viscometer at 40° C. (No. 1 rotor) was 9 (mPa·s).

(Preparation of PET Support)

A PET with a solid viscosity of IV=0.66 (measured at 25° C. in phenol/tetrachlorethane=6/4 (weight ratio)) was prepared from terephthalic acid and ethylene glycol by a conventional method. This was pelletized, dried for 4 hr at 130° C., melted at 300° C., extruded from a T-shape die, and rapidly cooled to prepare an unstretched film with a thickness of 175 micrometers following heat fixing.

This film was longitudinally stretched 3.3-fold with rolls of varying peripheral speed and then transversely stretched 4.5-fold. The temperatures employed in these processes were 110° C. and 130° C., respectively. Subsequently, heat fixing was conducted for 20 sec at 240° C., and 4 percent softening was conducted transversely at the same temperature. After slitting the chuck of a tenter, double-end gnarl processing was conducted, the film was wound at 4 kg/cm², and a roll 175 micrometers thick was obtained.

(Surface Corona Treatment)

Both surfaces of the support were treated at 20 m/min at room temperature with the 6 KVA model of a solid-state corona processor made by Pillar Co. It was determined from the values of the current and voltage read at the time that the support was treated with 0.375 kV·A·min/m². The processing frequency was 9.6 kHz and the gap clearance between the electrodes and the dielectric roll was 1.6 mm.

(Preparation of Undercoated Support)

(1) Preparation formula (1) of undercoating layer coating
solution (for forming an undercoating on the photosensitive
layer side)

| | | |
|---|---|---|
| Pes resin A-515GB (30 percent solution) | 234 | g |
| made by Takamatsu Yushi (K.K.) | | |
| 10 percent solution of polyethylene | 21.5 | g |
| glycol monononylphenylether (average | | |
| ethylene oxide number = 8.5) | | |
| MP-1000 (polymer microparticle) made by | 0.91 | g |
| Soken Chemicals (Ltd.) | | |
| Distilled water | 744 | mL |
| Formula (2) (for first layer on back side) | | |
| Butadiene-styrene copolymer latex (40 | 131 | g |
| weight percent solid component, | | |
| butadiene/styrene weight ratio = 32/68) | | |
| Sodium salt of 2,4-dichloro-6-hydroxy- | 5.1 | g |
| S-triazine (8 weight percent aqueous | | |
| solution) | | |
| 1 Weight percent aqueous solution of | 10 | mL |
| sodium laurylbenzene sulfonate | | |
| Distilled water | 854 | mL |
| Formula (3) (for second layer on back side) | | |
| SnO₂/SbO (9/1 weight ratio, average | 62 | g |
| particle diameter 0.038 micrometer, 17 | | |
| percent dispersion) | | |
| Gelatin (10 weight percent aqueous | 65.7 | g |
| solution) | | |
| Metrose TC-5 (2 weight percent aqueous | 6.3 | g |
| solution) made by Shinetsu Chemicals | | |
| (Ltd.) | | |
| MP-1000 (polymer microparticle) made by | 0.01 | g |
| Soken Chemicals (Ltd.) | | |
| 1 Weight percent aqueous solution of | 10 | mL |
| sodium dodecylbenzene sulfonate | | |
| Distilled water | 856 | mL |

(Preparation of Undercoated Support)

Both sides of a biaxially stretched polyethylene terephthalate support 175 micrometers in thickness were treated by corona discharge. Undercoating formula (1) was then applied with a wire bar to 6.6 mL/m² (per side) as a wet coating on one side (the photosensitive layer side) and dried for 5 min at 180° C. Undercoating formula (2) was then applied with a wire bar to 5.7 mL/m² on the back side and dried for 5 min at 180° C. Further, undercoating formula (3) was then applied with a wire bar to 5.7 mL/m² to 5.7 mL/m² to the back side and dried for 6 min at 180° C. to prepare an undercoated support.

(Preparation of Back Side Coating Solution)

(Preparation of Solid Microparticle Dispersion (a) of Base Precursor)

64 g of base precursor compound 11, 28 g of diphenyl sulfone compound 12, and 10 g of the surfactant Demol N made by Kao Corporation were admixed to 220 mL of distilled water. The mixed solution was bead dispersed in a sand mill (¼ gallon sand grinder mill, made by Imex (Ltd.)), yielding a solid particle codispersion of base precursor compound and diphenyl sulfone with an average particle diameter of 0.2 micrometer. (Preparation of solid microparticle dispersion of dye) 9.6 g of cyanine dye compound 13 and 5.8 g of sodium p-alkylbenzene sulfonate were mixed with 305 mL of distilled water and the mixed solution was bead dispersed in a sand mill (¼ gallon sand grinder mill, made by Imex (Ltd.)) to obtain a solid microparticle dispersion of dye with an average particle diameter of 0.2 micrometer.

(Preparation of Antihalation Layer Coating Solution)

17 g of gelatin, 9.6 g of polyacrylamide, 70 g of the above-described solid microparticle dispersion (a) of base precursor, 56 g of the above-described solid microparticle dispersion of dye, 1.5 g of polymethyl methacrylate microparticles (average particle size 8 micrometers), 2.2 g of sodium polyethylene sulfonate, 0.2 g of blue dye compound 14, and 844 mL of H₂O were admixed to prepare an antihalation layer coating solution.

(Preparation of Back Surface Protective Layer Coating Solution)

In a vessel heated to 40° C. were admixed 50 g of gelatin, 0.2 g of sodium polystyrene sulfonate, 2.4 g of N,N-ethylenebis(vinylsulfoneacetamide), 1 g of sodium t-octylphenoxyethoxyethane sulfonate, 30 mg of compound 15, 32 mg of C₈F₁₇SO₃K, 64 mg of C₈F₁₇SO₂N(C₃H₇) (CH₂CH₂O)₄(CH₂)₄SO₃Na, and 950 mL of H₂O, yielding a back surface protective layer coating solution.

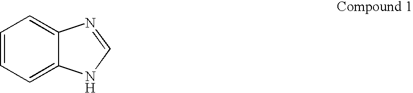

COMPOUND 2

K₃IrCl₆

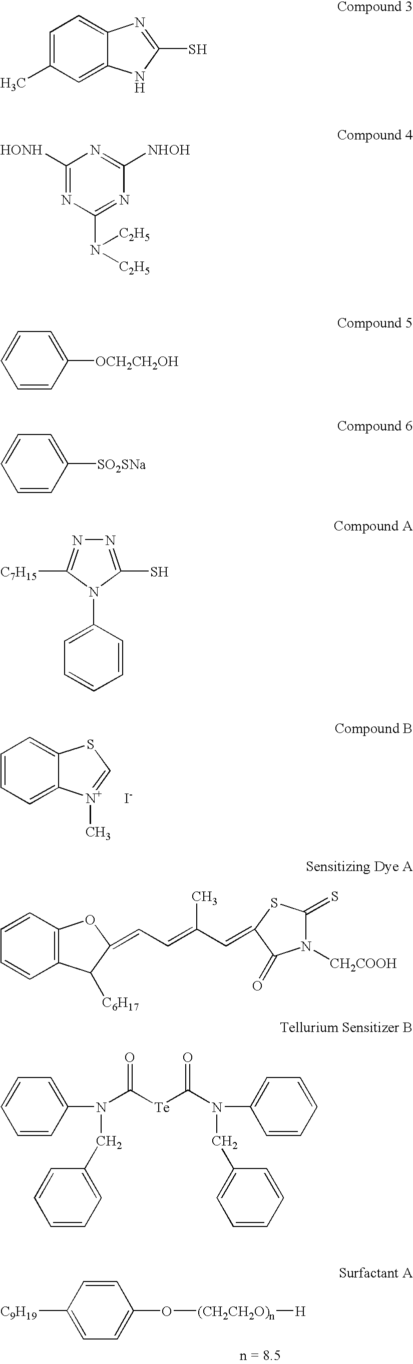

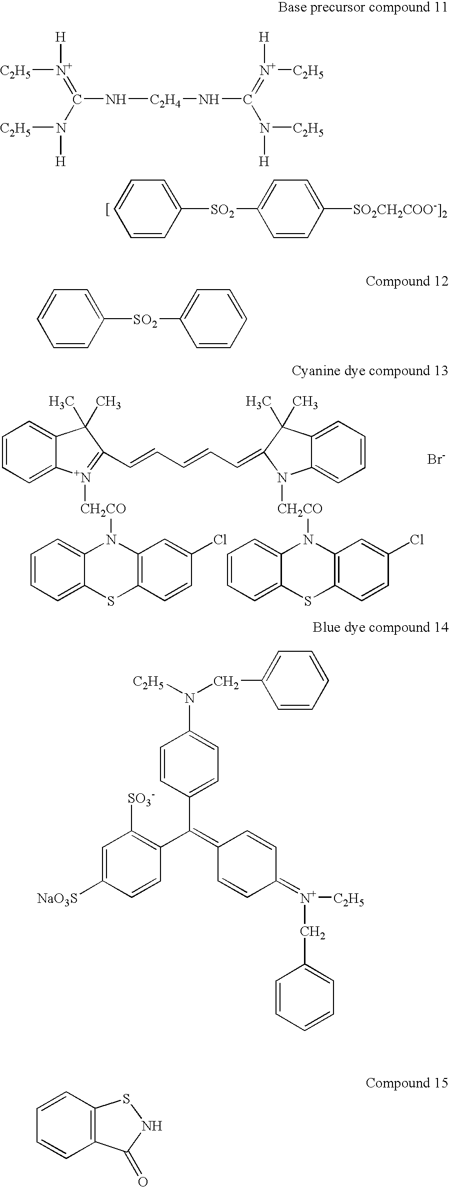

(Preparation of Photothermographic Material)

The antihalation layer coating solution was applied to the back surface side of the above-described undercoated polyethylene terephthalate film (support) in such an amount that a solid amount of the solid microparticle dye is 0.04 g/m². Further, the coating solution of the back surface protective layer was simultaneously multilayer coated in such an amount that gelatin is coated in 2 g/m². These were dried to obtain an antihalation back layer.

On the opposite surface from the back surface, the slide bead coating method was employed to multilayer coat, sequentially and simultaneously from the underlayer surface outward, an emulsion layer, an intermediate layer, a first protective layer, and a second protective layer. Samples of photothermographic material were prepared.

The coating was conducted at a speed of 160 m/min. The gap between the front end of the coating die and the support was set to 0.18 mm and the pressure in the vacuum chamber was set 392 Pa below atmospheric pressure. Next, in a chilling zone, the coating was blown with air with a dry sphere temperature of 18° C. and a wet sphere temperature of 12° C. for 30 sec to cool the coating solution. In a helical rising type drying zone, the coating was blown for 200 sec with dry air with a dry sphere temperature of 30° C. and a wet sphere temperature of 18° C., passed for 30 sec through a 70° C. dry zone, and then cooled to 25° C. to volatize the solvent in the coating solution. The average air speed of the air blown onto the coating solution film surface in the chilling zone and the drying zone was 7 m/sec.

The photothermographic material thus manufactured was employed in Example 2.

### EXAMPLE 2

Protective carriers (1) to (6) were produced from the materials indicated in Table 1.

Polypropylene with a basis weight of 495 g/m² and a thickness of 550 micrometers was employed in the material of protective carrier (1).

Paper prepared from the following starting materials was employed in the material of protective carriers (2) to (5): N30L70 was employed as the starting material pulp in protective carrier (2), N50L50 in protective carriers (3) and (4), and N100L0 in protective carrier (5). Here material N denotes pulp prepared from pine and material L denotes pulp prepared from birch; the numbers denote the ratio. Both of these were BKP prepared by the ECF method. Aluminum sulfate was employed as sizing on protective carrier (2). Alkyl ketene dimer (product name SPK287 made by Arakawa Kagaku Kogyo K.K.) was employed as sizing and cationic starch (product name CATO304L made by NSC Japan) was employed as fixing agent on protective carriers (3) to (5). NaOH was added in suitable quantity to achieve pH 7.5. A Fourdrinier paper machine was employed to make paper. The material employed in protective carrier (4) was surface treated. In the surface treatment, UV-setting OP varnish (dye-cured in-line offset OP varnish made by Dainippon Ink Kagaku Kogyo (K.K.)) was printed to 2 g/m² on both sides by offset printing using a PS plate.

Commercial beverage carton paper stock (Prime 320 made by Stora Enso Co.) was employed as the material of protective carrier (6).

TABLE 1

| Protective | | Basis | | | | | | |
|---|---|---|---|---|---|---|---|---|
| carrier | | weight | Thickness | | Fixing | pH | Extracted | Surface |
| No. | Material | (g/m²) | (micrometers) | Sizing | agent | adjuster | pH | treatment |
| (1) | PP | 495 | 550 | — | — | — | — | No |
| (2) | Paper | 320 | 475 | Aluminum | — | NaOH | 7.5 | No |
| | (N30L70) | | | sulfate | | | | |
| (3) | Paper | 320 | 475 | AKD | Cationic | NaOH | 7.5 | No |
| | (N50L50) | | | | starch | | | |
| (4) | Paper | 320 | 475 | AKD | Cationic | NaOH | 7.5 | No |
| | (N50L50) | | | | starch | | | |
| (5) | Paper | 320 | 475 | AKD | Cationic | NaOH | 7.5 | No |
| | (N100L0) | | | | starch | | | |

(Note):
“PP” denotes polypropylene and “AKD” denotes alkyl ketene dimer.

These materials were flat punched with a Thomson blade and assembled to obtain protective carriers (B4) of the shape shown in FIG. 1(a). Next, 151 sheets of the photothermographic material prepared by the method described in the manufacturing example were stacked and packed. During packing, the emulsion surface was placed facing the bottom of the protective carrier. The protective carriers that had been packed with the photothermographic material were inserted into center-sealed light-blocking moisture-resistant bags comprised of a material obtained by stretching the mixture of the composition indicated in Table 2 to 40 micrometers to obtain a film A which was then laminated in the sequence indicated in Table 3. Degassing was conducted to reduce the quantity of air within the bags to from 380 to 420 mL after which the two ends were heat sealed (FIG. 3). Then, as indicated in FIG. 4, the two ends were folded over and secured with a label 17. The following storage test was then conducted. This processing was conducted under environmental conditions of 23° C. and a relative humidity of 60 percent.

TABLE 2

| | Weight |
|---|---|
| Component | percent |
| Furnace carbon black (light-blocking | 5.0 |
| substance) (manufactured in a 1,250 to | |
| 1,600° C. furnace using ethylene bottom oil as | |
| starting material; pH 8.0, average particle | |
| diameter 20 nm, volatile component 0.6 | |
| percent, sulfur component content 0.05 | |
| percent, free sulfur content less than or | |
| equal to 20 ppm) | |
| Erucic acid amide (lubricant) | 0.05 |
| Calcium stearate (lubricant) | 0.5 |
| Hindered phenol oxidation inhibitor (melting | 0.05 |
| point greater than or equal to 110° C.) | |
| Ethylene.4-methylpentene-1 copolymer resin | 79.4 |
| (MFR 2.0 g/10 min, density 0.920 g/cm³) | |
| Homopolyethylene resin | 15 |
| (MFR 2.4 g/10 min, density 0.921 g/cm³) | |

TABLE 3

| | Thickness |
|---|---|
| Layer | (micrometers) |
| Film A | 40 |
| Biaxially stretched polyester resin film | 9 |
| (19 degree slip angle) | |
| Extrusion laminate adhesive layer of | 13 |
| homopolyethylene resin (MFR 4.5 g/10 min, | |
| density 0.918 g/cm³) | |
| Dry laminate adhesive layer | 2 |
| Soft aluminum foil | 6.5 |
| Biaxially strength nylon 6 resin film | 12 |

### TEST EXAMPLE 1

### Evaluation of the Effects on Photographic Properties

Product that had been packed to block light and resist moisture using protective carriers (1) to (6) was stored under conditions A and conditions B below, gradation exposed according to the method described in Patent Application 2001-201986, and then developed.

Conditions A: storage for 30 days in a 30±1° C. fixed-temperature environment.

Conditions B: storage for 2 days in a 50±2° C. fixed-temperature environment.

The optical density of the image formed on the 151^{st} sheet of photothermographic material directly in contact with the bottom of the protective carrier, the optical density of images formed on the first through fifth sheets of photothermographic material not in direct contact with the bottom of the protective carrier, and the average (ten-sheet average) of the optical density of images formed on the 146^{th} through 150^{th} sheets of photothermographic material were compared and the differences in optical density and gradation calculated. The results are given in Table 4 below. The difference in density was desirably not greater than ±0.03 and the difference in gradation desirably not greater than ±0.05. Protective carriers (3) to (6) of the present invention achieved results clearly superior to those of conventional formula protective carrier (2).

TABLE 4

| | Conditions A | | | Conditions B | | |
|---|---|---|---|---|---|---|
| | Difference | Difference | | Difference | Difference | |
| Protective | with | with high | Difference | with | with high | Difference |
| carrier | low-exposure | exposure | in | low-exposure | exposure | in |
| No. | density | density | gradation | density | density | gradation |
| (1) | −0.01 | −0.01 | −0.01 | ±0.00 | ±0.00 | +0.02 |
| (2) | −0.05 | +0.01 | −0.12 | −0.08 | +0.06 | −0.30 |
| (3) | −0.02 | ±0.00 | −0.03 | −0.01 | +0.01 | −0.02 |
| (4) | +0.01 | ±0.00 | −0.03 | +0.01 | ±0.00 | −0.02 |
| (5) | −0.01 | ±0.00 | −0.02 | −0.01 | ±0.00 | −0.01 |
| (6) | −0.01 | +0.01 | −0.02 | ±0.00 | +0.01 | −0.02 |

### TEST EXAMPLE 2

### Evaluation of Paper Dust Generation

Two sheets each of protective carriers (1) to (6) that had been cut to size B4 were prepared, the protective carriers were knocked against each other at a rate of once per second in a class 100 clean room, and the surrounding cleanliness was measured with a particle counter (KR-12A made by Ryon). The results are given in Table 5. Protective carriers (3) to (6) of the present invention produced good results.

TABLE 5

| | Paper Dust particles by size (no/cft) | | |
|---|---|---|---|
| | 0.5 | 1.0 | 5.0 |
| Protective | micrometer or | micrometer or | micrometer or |
| carrier No. | more | more | more |
| (1) | 300 | 160 | 10 |
| (2) | 1260 | 960 | 160 |
| (3) | 200 | 100 | 10 |
| (4) | 240 | 160 | 20 |
| (5) | 170 | 60 | 0 |
| (6) | 300 | 150 | 30 |

### TEST EXAMPLE 3

### Bending Evaluation

Protective carriers (2) to (6) were prepared by cutting to a width of 100 mm and processed with known pressed rule lines by pressing in a direction orthogonal to the grain of the paper with a round blade for line pressing (t 0.7 front end R 0.35). The protective carriers were then repeatedly folded upward into a “V” shape (1350 angle) from a flat position (0° angle) and returned to the original flat position (0° angle) 50 times, after which the repulsive torque when held in a “V” shape (135° angle) was measured. The repulsive torque of protective carriers (3) to (6) of the present invention was low and durability was clearly good.

TABLE 6

| | Repulsive torque (Ncm/100 mm) | | |
|---|---|---|---|
| Protective | | | Reduction |
| carrier No. | 2^{nd} time | 50^{th} time | rate |
| (2) | 4.35 | 2.15 | 49% |
| (3) | 4.49 | 2.97 | 66% |
| (4) | 4.66 | 3.50 | 75% |
| (5) | 4.57 | 3.22 | 70% |
| (6) | 4.49 | 3.10 | 69% |

Since protective carriers (2) to (6) were made of 100 percent virgin pulp, they had excellent use potential as recycled paper starting materials. Since protective carrier (1) was made of polypropylene, considerable effort and cost were required for its disposal.

The packing material of the present invention suppresses generation of paper dust and prevents occurrence of white spot defect in recorded images on a sheet recording material that was packed in the packing material even when the packing material is not subjected to surface treatment. Further, the packing material of the present invention effectively prevents deterioration of photographic properties when applied to dry-type sheet recording materials. Still further, since the packing material of the present invention has high hinge durability, it can be effectively employed as a packing material for sheet recording materials such as photothermographic materials and heat-sensitive recording materials.

What is claimed is:

1. A packing material for a sheet recording material, which contains a paper material comprising an alkyl ketene dimer and cationic starch, the extraction pH of the paper material being within the range of 6.5 to 9.0.

2. The packing material for a sheet recording material according to claim 1 wherein 50 weight percent or more of the starting material for producing said paper material is a needle-leaf-tree bleached kraft pulp (NBKP) that is bleached by the ECF method.

3. The packing material for a sheet recording material according to claim 1, for packing the sheet recording material with at least a portion of the sheet recording material being in direct contact with the packing material.

4. A package in which an X-ray photography sheet recording material is packed in the packing material according to claim 1.

5. A package in which a photothermographic material or a heat-sensitive recording material is packed in the packing material according to claim 1.
